(19) United States
(12) Patent Application Publication
(10) Pub. No.: US 2024/0298283 A1
(43) Pub. Date: Sep. 5, 2024

(54) COMMUNICATION METHOD AND APPARATUS, DEVICE, STORAGE MEDIUM, CHIP, PRODUCT, AND PROGRAM

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN); Xinlei YU, Dongguan (CN)

(21) Appl. No.: 18/662,052

(22) Filed: May 13, 2024

Related U.S. Application Data
(63) Continuation of application No. PCT/CN2021/132183, filed on Nov. 22, 2021.

(51) Int. Cl. H04W 56/00; H04W 84/06

(52) U.S. Cl. CPC H04W 56/0045; H04W 56/0015; H04W 84/06

(57) ABSTRACT

A communication method includes: a terminal device acquires a first offset increment configured by a network device; the terminal device determines a terminal device-specific offset according to the first offset increment and a cell-level common offset; and the terminal device determines a time-domain resource position for an uplink transmission of the terminal device according to the terminal device-specific offset.

### CROSS-REFERENCE TO RELATED APPLICATION

This application is a continuation of International Application No. PCT/CN2021/132183 filed on Nov. 22, 2021, the disclosure of which is hereby incorporated by reference in its entirety.

### BACKGROUND

At present, the 3rd Generation Partnership Project (3GPP) is researching the Non-Terrestrial Network (NTN) technology. The NTN generally provides communication services to terrestrial users by means of satellite communications.

In the NTN, how a terminal device determines a time-domain resource position for sending information to a network device or a satellite has been a concern in this field.

### SUMMARY

Embodiments of the present disclosure relate to the technical field of mobile communications.

Embodiments of the present disclosure provide a communication method and apparatus, a device, a storage medium, a chip, a product and a program.

In a first aspect, the embodiments of the present disclosure provide a communication method including: a terminal device acquires a first offset increment configured by a network device; the terminal device determines a terminal device-specific offset according to the first offset increment and a cell-level common offset; and the terminal device determines a time-domain resource position for an uplink transmission of the terminal device according to the terminal device-specific offset.

In a second aspect, the embodiments of the present disclosure provide a communication method including: a network device configures a first offset increment for a terminal device; the network device determines a terminal device-specific offset according to the first offset increment and a cell-level common offset; and the network device determines a time-domain resource position for an uplink transmission of the terminal device according to the terminal device-specific offset.

In a third aspect, the embodiments of the present disclosure provide a communication apparatus including a processor; a transceiver connected to the processor; and a memory configured to store instructions executable by the processor. The processor is configured to invoke and run the executable instructions to perform operations of: acquiring a first offset increment configured by a network device; determining a terminal device-specific offset according to the first offset increment and a cell-level common offset; and determining a time-domain resource position for an uplink transmission of the terminal device according to the terminal device-specific offset.

### BRIEF DESCRIPTION OF THE DRAWINGS

The drawings described herein are adopted to provide a further understanding to the present disclosure and form a part of the present disclosure. Schematic embodiments of the present disclosure and descriptions thereof are adopted to explain the present disclosure and not intended to form improper limits to the present disclosure. In the drawings:

FIG. 1 is a diagram of a scenario to which an embodiment of the present disclosure is applied;

FIG. 2 is a schematic diagram of architecture of a communication system according to an embodiment of the present disclosure;

FIG. 3 is a schematic diagram of architecture of a communication system according to another embodiment of the present disclosure;

FIG. 4 is a schematic diagram of an NTN scenario based on a transparent payload satellite according to an embodiment of the present disclosure;

FIG. 5 is a schematic diagram of an NTN scenario based on a regenerative payload satellite according to an embodiment of the present disclosure;

FIG. 6 is a schematic diagram of a time synchronization manner at a network device side;

FIG. 7 is a schematic diagram of a timing relationship of an NTN system in a first case;

FIG. 8 is a schematic diagram of a timing relationship of an NTN system in a second case;

FIG. 9 is a flowchart of a communication method according to an embodiment of the present disclosure;

FIG. 10 is a schematic diagram showing determination of a time-domain resource position for an uplink transmission according to an embodiment of the present disclosure;

FIG. 11 is a flowchart of a communication method according to another embodiment of the present disclosure;

FIG. 12 is a schematic diagram showing determination of a time-domain resource position for an uplink transmission according to another embodiment of the present disclosure;

FIG. 13 is a flowchart of a communication method according to another embodiment of the present disclosure;

FIG. 14 is a schematic diagram showing determination of a time-domain resource position for an uplink transmission according to an embodiment of the present disclosure;

FIG. 15 is a schematic structural diagram of a communication apparatus according to an embodiment of the present disclosure;

FIG. 16 is a schematic structural diagram of a chip according to an embodiment of the present disclosure.

### DETAILED DESCRIPTION

The technical schemes of the embodiments of the present disclosure would be clearly and completely described in conjunction with the accompanying drawings in the embodiments of the present disclosure. It is apparent that the described embodiments are only part of the embodiments of the present disclosure, not all the embodiments. All other embodiments obtained by those of ordinary skill in the art with respect to the embodiments of the present disclosure without creative efforts all fall within the scope of protection of the present disclosure. The technical scheme described in the embodiments of the present disclosure can be arbitrarily combined without conflict. In the description of the present disclosure, “multiple” means two or more, unless expressly specified otherwise.

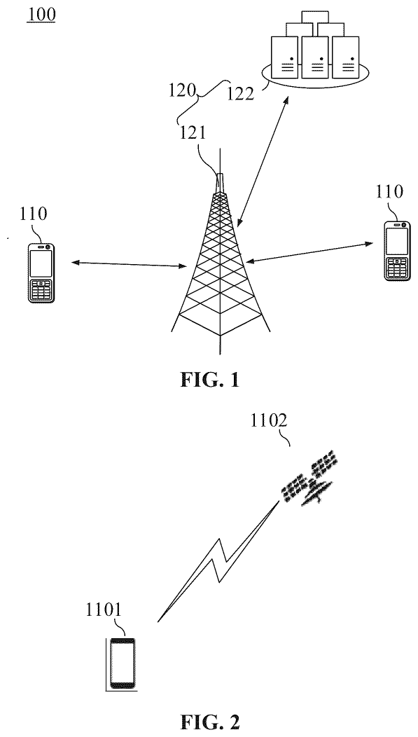

FIG. 1 is a diagram of a scenario to which a communication method is applied according to an embodiment of the present disclosure. As shown in FIG. 1, the communication system 100 may include a terminal device 110 and a network device 120. The network device 120 may communicate with the terminal device 110 through an air interface. Multi-service transmission is supported between the terminal device 110 and the network device 120.

It should be understood that the embodiments of the present disclosure are only illustrative with the communication system 100 but are not limited thereto. That is to say, the technical schemes of the embodiments of the present disclosure can be applied to various communication systems, such as: a Long Term Evolution (LTE) system, a LTE Time Division Duplex (TDD), an Universal Mobile Telecommunications System (UMTS), an Internet of Things (IoT) system, a Narrow Band Internet of Things (NB-IoT) system, an Enhanced Machine-Type Communications (eMTC) system, a 5G communication system (also referred to as a New Radio (NR) communication system), or future communication system (e.g. 6G communication system, or 7G communication system), etc.

In the communication system 100 shown in FIG. 1, the network device 120 may include an access network device 121 that communicates with the terminal device 110. The access network device 121 may provide communication coverage for a particular geographic area and may communicate with a terminal device 110 located within the coverage.

The terminal device or other device in the present disclosure may be referred to as User Equipment (UE), a Mobile Station (MS), a Mobile Terminal (MT), a subscriber unit, a subscriber station, a mobile station, a remote station, a remote terminal, a mobile device, a subscriber terminal, a terminal, a wireless communication apparatus, a subscriber agent, or a subscriber device. The terminal device or other device may include one or at least a combination of two of the following: an Internet of Things (IoT) device, a satellite terminal, a Wireless Local Loop (WLL) station, a Personal Digital Assistant (PDA), a handheld device with wireless communication function, a computing device or other processing device connected to a wireless modem, a server, a mobile phone, a Pad, a computer with wireless transceiver function, a palmtop computer, a desktop computer, a PDA, a portable media player, a smart speaker, a navigation device, a wearable device such as a smart watch, smart glasses, a smart necklace, a pedometer, a digital TV, a Virtual Reality (VR) terminal device, an Augmented Reality (AR) terminal device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, and a vehicle, a vehicle-mounted device, a vehicle-mounted module or a wireless modem in a Vehicle-to-Everything (V2X) system, a handheld device, Customer Premise Equipment (CPE), or smart home appliances.

The network device 120 in the embodiments of the present disclosure may include the access network device 121 and/or a core network device 122.

The access network device 121 may include one or at least a combination of two of the following: an Evolutionary Base Station (Node B, eNB or eNodeB) in a Long Term Evolution (LTE) system, a Next Generation Radio Access Network (NG RAN) device, a Base Station (gNB) in an NR system, a small station, a micro station, a wireless controller in a Cloud Radio Access Network (CRAN), an access point in a Wireless-Fidelity (Wi-Fi), a Transmission Reception Point (TRP), a relay station, an access point, an vehicle-mounted device, a wearable device, a hub, a switch, a bridge, a router, a network device in a future evolved Public Land Mobile Network (PLMN), etc.

The core network device 122 may be a 5G Core (5GC) device, and the core network device 122 may include one or at least a combination of two of the following: an Access and Mobility Management Function (AMF), an Authentication Server Function (AUSF), a User Plane Function (UPF), a Session Management Function (SMF), or a Position Management Function (LMF). In other embodiments, the core network device may also be an Evolved Packet Core (EPC) device of the LTE network, for example, a Session Management Function+Core Packet Gateway (SMF+PGW-C) device. It is to be understood that SMF+PGW-C device may implement the functions implemented by the SMF and PGW-C. In a process of network evolution, the core network device 122 may also be called by other names, or a new network entity may be formed by partitioning the functions of the core network, which is not limited in the embodiments of the present disclosure.

The terminal device 110 may be any terminal device, including but not limited to, a terminal device in wired connection or wireless connection with the network device 120 or other terminal devices.

The terminal device 110 may be used for the Device to Device (D2D) communication.

The communication between the functional units of the communication system 100 may be implemented by establishing a connection through a next generation (NG) interface.

For example, the terminal device sets up the air interface connection with the access network device through a NR interface, to transmit user plane data and control plane signaling. The terminal device may set up a control plane signaling connection with an AMF through an NG interface 1 (abbreviated as N1). The access network device, such as the gNB, may set up a user plane data connection with a UPF through an NG interface 3 (abbreviated as N3). The access network device may set up control plane signaling connection with the AMF through an NG interface 2 (abbreviated as N2). The UPF may set up the control plane signaling connection with an SMF through an NG interface 4 (abbreviated as N4). The UPF may exchange user plane data with a data network through an NG interface 6 (abbreviated as N6). The AMF may set up the control plane signaling connection with the SMF through an NG interface 11 (abbreviated as N11). The SMF may set up the control plane signaling connection with a PCF through an NG Interface 7 (abbreviated as N7).

FIG. 1 exemplarily illustrates one base station, one core network device and two terminal devices. In some embodiments, the wireless communication system 100 may include multiple base station devices and other numbers of the terminal devices may be included within the coverage of each base station, which is not limited in the embodiments of the present disclosure.

3GPP is researching the Non Terrestrial Network (NTN) technology. The NTN generally provides communication service to terrestrial users by means of satellite communication. Compared with terrestrial cellular network communication, the satellite communication has many unique advantages. First of all, the satellite communication is not limited by the user's region. For example, general land communication cannot cover areas such as oceans, mountains, or deserts where communication apparatuses cannot be set up or communication coverage is not done due to sparse population. For the satellite communication, because a satellite can cover a large area of the ground and the satellite can orbit around the earth, theoretically every corner of the earth can be covered by the satellite communication. Secondly, the satellite communication has high social value. The satellite communication can cover, at a lower cost, remote mountainous areas and poor and backward countries or regions, so that people in these areas can enjoy advanced voice communication and mobile internet technology, which is conducive to narrowing the digital divide with developed areas and promoting the development of these areas. Thirdly, the satellite communication has a long communication distance, and the increase of communication distance will not significantly increase the communication cost. Finally, the satellite communication has high stability and is not limited by natural disasters.

The NTN technology may be combined with various communication systems. For example, the NTN technology may be combined with the NR system to form a NR-NTN system. For another example, the NTN technology may be combined with the IoT system to form an IoT-NTN system. By way of example, the IoT-NTN system may include a NB-IoT-NTN system and an eMTC-NTN system.

FIG. 2 is a schematic diagram of architecture of a communication system according to an embodiment of the present disclosure. As shown in FIG. 2, the communication system includes a terminal device 1101 and a satellite 1102, and the terminal device 1101 may perform the wireless communication with the satellite 1102. The network formed between the terminal device 1101 and the satellite 1102 may also be referred to as the NTN. In the architecture of the communication system shown in FIG. 2, the satellite 1102 may have functions of a base station and directly communicates with the terminal device 1101. Under this system architecture, the satellite 1102 may be called the network device. In some embodiments of the present disclosure, multiple network devices 1102 may be included in the communication system, and other numbers of terminal devices may be included within the coverage of each network device 1102, which is not limited in the embodiments of the present disclosure.

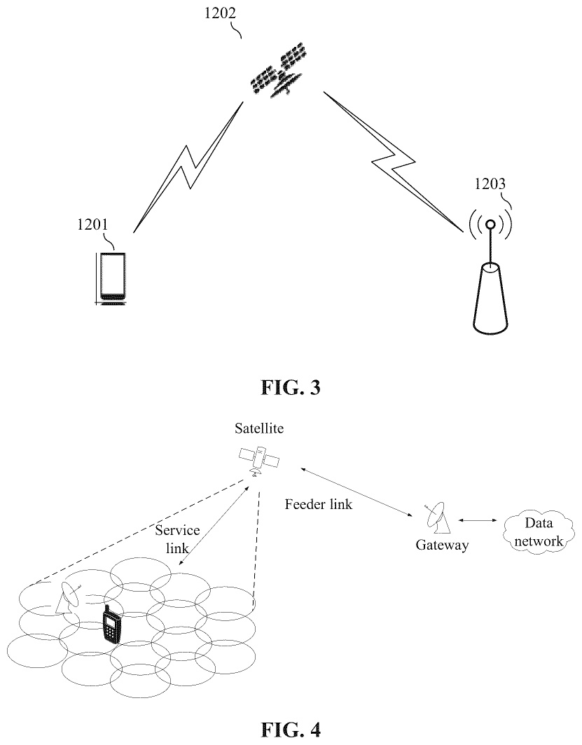

FIG. 3 is a schematic diagram of architecture of a communication system according to another embodiment of the present disclosure. As shown in FIG. 3, the communication system includes a terminal device 1201, a satellite 1202 and a base station 1203. The wireless communication may be performed between the terminal device 1201 and the satellite 1202, and the communication may be performed between the satellite 1202 and the base station 1203. The network formed between the terminal device 1201, the satellite 1202 and the base station 1203 may also be referred to as the NTN. In the architecture of the communication system shown in FIG. 3, the satellite 1202 may not have the functions of the base station, and the communication between the terminal device 1201 and the base station 1203 needs to be relayed through the satellite 1202. Under this system architecture, the base station 1203 may be called the network device. In some embodiments of the present disclosure, multiple network devices 1203 may be included in the communication system, and other numbers of terminal devices may be included within the coverage of each network device 1203, which is not limited in the embodiments of the present disclosure. The network device 1203 may be the network device 120 in FIG. 1.

It is to be understood that the satellite 1102 or satellite 1202 includes, but is not limited to, a Low-Earth Orbit (LEO) satellite, a Medium-Earth Orbit (MEO) satellite, a Geostationary Earth Orbit (GEO) satellite, a High Elliptical Orbit (HEO) satellite, etc. A satellite covers the ground with multiple beams. For example, one satellite may form dozens or even hundreds of beams to cover the ground. In other words, one satellite beam may cover the ground area with a diameter of tens to hundreds of kilometers, so as to ensure the coverage of the satellite and improve the system capacity of the entire satellite communication system.

As an example, the orbital altitude of LEO ranges from 500 km to 1500 km, and the corresponding orbital period is about 1.5 hours to 2 hours. The signal propagation delay of single hop communication between users is generally less than 20 ms. The maximum satellite visual time is 20 minutes. The signal propagation distance is short, the link loss is less, and the requirements for the transmit power of the terminal device is not high. The orbital altitude of GEO is 35786 km, and the rotation period around the Earth is 24 hours. The signal propagation delay of single hop communication between users is generally 250 ms.

In order to ensure the coverage of the satellite and improve the system capacity of the entire satellite communication system, the satellite covers the ground with multiple beams, and one satellite can form dozens or even hundreds of beams to cover the ground; and one satellite beam can cover the ground area with a diameter of tens to hundreds of kilometers.

It is be noted that FIG. 1 to FIG. 3 only illustrate by way of example the system to which the present disclosure applies and of course the method shown in the embodiment of the present disclosure may also be applied to other systems. In addition, the terms “system” and “network” herein are often used interchangeably herein. In this disclosure, the term “and/or” is only to describe an association relationship between associated objects and represents that three kinds of relationships may exist. For example, A and/or B may represent three conditions: i.e., independent existence of A, existence of both A and B and independent existence of B. In addition, the character “/” in the present disclosure generally indicates that the associated objects before and after this character is in an “or” relationship. It is to be understood that the reference to “indication” in the embodiments of the present disclosure may be a direct indication, may be an indirect indication, or may be indicative of an association. For example, A indicates B, which may mean that A directly indicates B, for example, B may be obtained through A; it may also mean that A indirectly indicates B, for example, A indicates C, and B may be obtained by C; and it may also indicate that there is an association between A and B. It is also to be understood that the term “correspondence” may mean that there is a direct correspondence or an indirect correspondence between the two, may also mean that there is an association relationship between the two, and may also be a relationship between indication and being indicated, configuration and being configured, etc. It is also to be understood that “predefined”, “specified in a protocol”, “predetermined” or “predefined rules” may be achieved by pre-storing corresponding codes, tables or other means used for indicating relevant information in devices (e.g., including terminal devices and network devices), and the present disclosure is not limited to the specific implementation thereof. For example, predefined may refer to what is defined in the protocol. It should also be understood that, in the embodiments of the present disclosure, the “protocol” may be a standard protocol in the communication field. For example, the protocol may include an LTE protocol, an NR protocol, and related protocols applied in future communication systems, which are not limited in the present disclosure.

According to the functions provided by the satellites, the satellites may be divided into two types: transparent payload and regenerative payload. For the transparent payload satellite, it only provides the functions of radio frequency filtering, frequency conversion and amplification, and only transparent forwarding of signals is provided without changing the waveform signals forwarded by the transparent payload satellite. In addition the functions of the radio frequency filtering, the frequency conversion and the amplification, the regenerative payload satellite further provides the functions of demodulation/decoding, routing/conversion, coding/modulation. The regenerative payload satellite has some or all functions of the base station.

In the NTN, one or more gateways may be included for the communication between the satellite and the terminal.

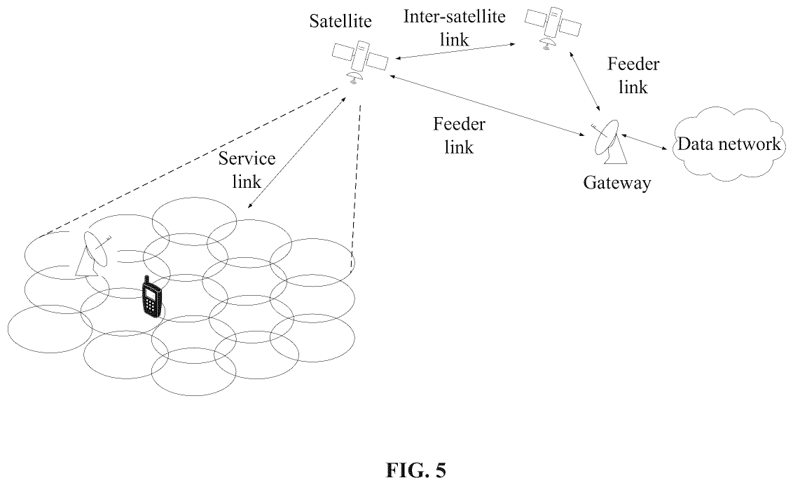

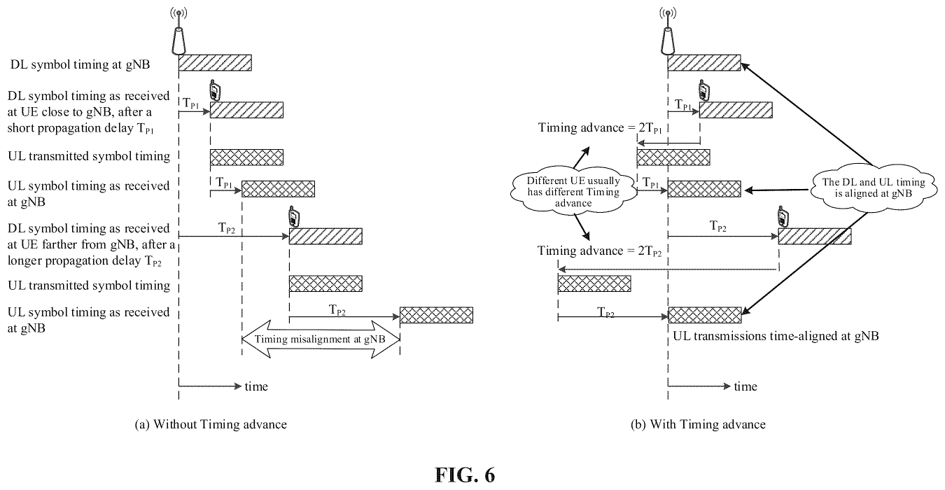

FIG. 4 is a schematic diagram of an NTN scenario based on a transparent payload satellite according to an embodiment of the present disclosure, and FIG. 5 is a schematic diagram of an NTN scenario based on a regenerative payload satellite according to an embodiment of the present disclosure.

As shown in FIG. 4, for the NTN scenario based on the transparent payload satellite, the gateway communicates with the satellite through a feeder link, and the satellite communicates with the terminal through a service link. As shown in FIG. 5, for the NTN scenario based on the regenerative payload satellite, the satellite communicates with another satellite through an Inter-satellite link, the gateway communicates with the satellite through the feeder link, and the satellite communicates with the terminal through the service link.

In FIG. 4 and FIG. 5, the gateway is configured to connect the satellite to the terrestrial common network (e.g. a data network). The feeder link is a link used for the communication between the gateway and the satellite. The service link is a link used for the communication between the terminal and the satellite. The Inter-satellite link exists in the architecture of the regenerative payload network.

In order to facilitate understanding of the technical schemes of the embodiments of the present disclosure, the technical technologies related to the embodiments of the present disclosure will be described below, and the following related technologies, as optional schemes, can be arbitrarily combined with the technical schemes of the embodiments of the present disclosure, all of which belong to the protection scope of the embodiments of the present disclosure.

An important feature of the uplink transmission is that different terminal devices have orthogonal multiple access in time and frequency, i.e., the uplink transmissions of different terminal devices from the same cell do not interfere with each other.

In order to ensure the orthogonality of the uplink transmissions and avoid intra-cell interference, the network device requires that times when signals, sent at the same time but on different frequency-domain resources, from different terminal devices arrive at the network device are basically aligned. In order to ensure the time synchronization at the network device side, the NR supports the mechanism of uplink timing advance.

At the network device side, an uplink clock is the same as a downlink clock, but there is an offset between an uplink clock and a downlink clock at the terminal device side. Different terminal devices have different uplink timing advances. By appropriately controlling the offset of each terminal device, the network device may control the times when the uplink signals from different terminal devices arrive at the network device. For a terminal device far away from the network device, due to a large transmission delay, it is necessary for the terminal device to send uplink data ahead of the terminal device close to the network device.

The network device determines a Timing Advance (TA) value for each terminal device based on measuring an uplink transmission of the terminal device. The network device sends a TA command to the terminal device in two manners.
1) An acquisition of an initial TA: in a random access process, the network device determines the TA value by measuring a received preamble, and sends the TA value to the terminal device through a Timing Advance Command field of a Random Access Response (RAR).
2) An adjustment of the TA under a Radio Resource Control (RRC) connected state: although the terminal device obtains the uplink synchronization with the network device during the random access process, the timing when the uplink signal arrives at the network device may change over time. Therefore, the terminal device needs to constantly update its uplink timing advance to maintain the uplink synchronization. If a TA of a certain terminal device needs to be corrected, the network device will send a Timing Advance (TA) command to the terminal device, and requires the terminal device to adjust the uplink timing. The TA command is sent to the terminal device through a Media Access Control Control Element (MAC CE).

In the Carrier Aggregation (CA) scenario, terminal devices may need to use different TAs for different uplink carriers, so a concept of the Timing Advance Group (TAG) is introduced in the standard. The network device configures up to 4 TAGS for each cell group of the terminal device, and configures, for each serving cell, the TAG associated with the serving cell. The terminal device maintains the TA separately for each TAG. Carriers may be divided into different TAGs according to different TA values of the carriers, and the TA values of the carriers in each TAG are the same.

FIG. 6 is a schematic diagram of a time synchronization manner at the network device side. As shown in FIG. 6(a), a DownLink (DL) symbol timing as received at a terminal device (UE) close to the network device (gNB) undergoes a short propagation delay T_{P1}, so that the UpLink (UL) transmission symbol timing is delayed by T_{P1} compared with the DL symbol timing of the network device (gNB), and the UL symbol timing as received at the network device (gNB) is delayed by T_{P1} compared with the UL transmission symbol timing. The DL symbol timing as received at a terminal device (UE) farther from the network device (gNB) undergoes a longer propagation delay T_{P2}, so that the UL transmission symbol timing is delayed by T_{P2} compared with the DL symbol timing of the network device (gNB), and the UL symbol timing as received at the network device (gNB) is delayed by T_{P2} compared with the UL transmission symbol timing. In this way, the network device (gNB) will receive, at different times, information transmitted by different terminal devices due to timing misalignment of the network device (gNB).

As shown in FIG. 6(b), different terminal devices generally have different time advances, and a time advance 2T_{P1} is set for a terminal device close to the network device, and a time advance 2T_{P2} is set for a terminal device farther away from the network device. In this way, the DL timing is aligned with the UL timing at the network device (gNB), so that the UL transmissions are aligned at the network device (gNB).

In a terrestrial communication system, a propagation delay of signal communication is usually less than 1 ms. In the NTN system, due to a long communication distance between a terminal device and a satellite (or a network device), the propagation delay of the signal communication is very large, having a range from tens of milliseconds to hundreds of milliseconds, which is associated with an orbital altitude of the satellite and a service type of satellite communication. In order to deal with the large propagation delay, the timing relationship of the NTN system needs to be enhanced compared with the NR system.

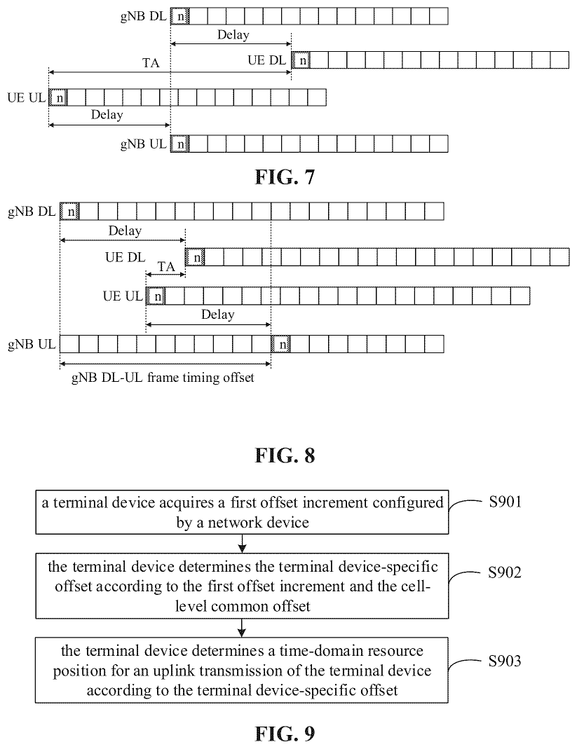

In the NTN system, same as in the NR system, the terminal device needs to consider an influence of a TA when an uplink transmission is performed. Due to the large propagation delay in the system, the TA value has a relatively large range. When the terminal device is scheduled to perform the uplink transmission in a slot n, the terminal device transmits ahead of time when the uplink transmission is performed in consideration of a round-trip propagation delay, so that when a signal arrives at the base station side, the signal may be in the slot n of the uplink at the base station side. Specifically, the timing relationship in the NTN system may include two cases as shown in FIG. 7 and FIG. 8 below, respectively.

FIG. 7 is a schematic diagram of a timing relationship of an NTN system in a first case. As shown in FIG. 7, same as in the NR system, the downlink slot at the network device side (gNB DL) is aligned with the uplink slot at the network device side (gNB UL). Accordingly, in order to align the uplink transmission of the terminal device (UE UL) with the uplink slot at the network device side, the terminal device needs to use a larger TA value, and the TA value is determined according to a delay which may be a delay between the UE DL and the gNB DL. When the uplink transmission is performed, a large offset, such as Koffset, is required to be introduced. The value of the Koffset may be determined based on the TA value.

FIG. 8 is a schematic diagram of a timing relationship of an NTN system in a second case. As shown in FIG. 8, there is an offset between the downlink slot at the network device side (gNB DL) and the uplink slot at the network device side (gNB UL), and this offset is a gNB DL-UL frame timing offset. In this case, if the uplink transmission of the terminal device (UE UL) is required to be aligned with the uplink slot at the network device side, the terminal device only needs to use a small TA value, and the TA value is determined according to a delay and the gNB DL-UL frame timing offset. The delay may be a delay between the UE DL and the gNB DL. However, in this case, the network device may need additional scheduling complexity to deal with the corresponding scheduling timing.

Based on the progress of NTN standardization in the 3GPP, following conclusions are drawn about a configuration of Koffset. 1. For the initial random access process, the network may configure a cell-level Koffset or a satellite beam-level Koffset through broadcasting. 2. For a terminal device in a connected state, the network may configure a terminal device-specific Koffset for the terminal device. 3. If the network does not configure the terminal device-specific Koffset, the terminal device uses a broadcasted Koffset. 4. The MAC CE is used for configuring the terminal device-specific Koffset. Whether RRC signaling can be used for configuring the terminal device-specific Koffset is still inconclusive.

The value range of the Koffset is associated with NTN scenarios. At present, the NTN supports the GEO, the LEO and other scenarios, and the value ranges of the Koffset (or the Koffset ranges) are different in different scenarios.

Table 1 provides Koffset ranges.

TABLE 1

| Option | Value range | Step size |
|---|---|---|
| Option 1: One value | [0]-[542] ms | Same as the unit of |
| range of K_offset | | K_offset |
| covering all scenarios | | |
| Option 2: Different value | LEO: [0]-[49] ms | Same as the unit of |
| ranges of K_offset for | MEO: [93]-[395] ms | K_offset |
| different scenarios | GEO: [477]-[542] ms | |

The network mainly makes reference to the TA to configure the value of the Koffset. For example, for the cell common Koffset broadcasted by the network, the network needs to configure the Koffset according to a maximum TA supported by the cells. For the terminal device-specific Koffset, the network may make reference to the TA of the terminal device to configure the Koffset. For the cell common Koffset broadcasted by the network, it is apparent that an absolute value of the Koffset is required to be configured. For the configuration of the terminal device-specific Koffset, an intuitive way is also that the absolute value of the Koffset is configured. As can be seen from the above table, for the option 1, the corresponding Koffset has a wide value range. In a case where a certain accuracy requirement for the Koffset is ensured, this manner for configuring the terminal device-specific Koffset needs to use more bits to support a wider Koffset range, which will lead to a larger payload size of the MAC CE.

In order to facilitate understanding of the technical schemes of the embodiments of the present disclosure, the technical schemes of the present disclosure will be described in detail below by way of specific embodiments. The above related technologies, as optional schemes, can be arbitrarily combined with the technical schemes of the embodiments of the present disclosure, all of which belong to the protection scope of the embodiments of the present disclosure. The embodiments of the present disclosure include at least some of following contents.

In the embodiments of the present disclosure, the terminal device determines the terminal device-specific offset based on the offset increment configured by the network device; and then determines the time-domain resource position for the uplink transmission of the terminal device according to the terminal device-specific offset. For example, the terminal device may determine the terminal device-specific offset based on the offset increment configured by the network device and the acquired offset. Exemplarily, the acquired offset may be the cell-level common offset, or a dedicated offset of the terminal device.

FIG. 9 is a flowchart of a communication method according to an embodiment of the present disclosure. As shown in FIG. 9, the method is applied to a terminal device or a processor in the terminal device. The method includes following operations S901 to S903.

In operation S901, a terminal device acquires a first offset increment configured by a network device.

The terminal device may receive the first offset increment sent by the network device. In some embodiments, the terminal device may receive, through downlink information, the first offset increment sent by the network device. In other embodiments, the terminal device may receive the first offset increment sent by another device that receives the first offset increment from the network device.

The first offset increment may be understood as a first offset change amount or a first offset adjustment amount. The first offset increment is used for adjusting the cell-level common offset. For example, in some embodiments, the first offset increment is used for raising the cell-level common offset through adjustment. In still other embodiments, the first offset increment is used for lowering the cell-level common offset through adjustment.

The first offset increment may be less than or equal to a difference between a maximum offset and a minimum offset that the terminal device is able to use. For example, if the terminal device is located at an edge of a cell corresponding to the network device, the terminal device will send the uplink information based on the maximum offset. If the terminal device is located at a center of the cell corresponding to the network device, the terminal device will send the uplink information based on the minimum offset. The first offset increment may be less than or equal to the difference between the maximum offset and the minimum offset.

The network device may broadcast the cell-level common offset; the network device may determine the terminal device-specific offset based on a delay of the terminal device; then determine the first offset increment based on the cell-level common offset and the terminal device-specific offset; and send the first offset increment to the terminal device.

In some embodiments, the network device may send the first offset increment to the terminal device in a case where it determines that the terminal device needs to update the offset. In other embodiments, the terminal device may send request information to the network device in a case where it determines that the terminal device needs to update the offset, so as to cause the network device to send the first offset increment to the terminal device. In still other embodiments, the network device may send the first offset increment to the terminal device every preset interval. In this case, the first offset increment may be 0 or not be 0.

In operation S902, the terminal device determines the terminal device-specific offset according to the first offset increment and the cell-level common offset.

The offset (e.g. the cell-level common offset or the terminal device-specific offset) in the embodiment of the present disclosure may also be referred to as a timing offset, a timing offset amount or an offset amount, etc. The cell-level common offset may be referred to as a cell common offset or a common offset in other embodiments.

The cell common offset may be stored in the terminal device, so that the terminal device may acquire the cell common offset from itself. In some embodiments, before the operation S901, the terminal device receives the cell common offset broadcasted by the network device, and stores the cell common offset.

In some embodiments, the cell common offset may be the maximum offset that the terminal device is able to use. In other embodiments, the cell common offset may be the minimum offset that the terminal device is able to use. In yet other embodiments, the cell common offset may be an average of the maximum offset and the minimum offset that the terminal is able to use. In some embodiments, the cell common offset may be associated with coverage of the network device and/or a distance between the network device and the ground.

In some embodiments, the terminal device may determine the terminal device-specific offset based on a sum of the cell common offset and the first offset increment. For example, the terminal device-specific offset is the sum of the cell common offset and the first offset increment. In other embodiments, the terminal device may determine the terminal device-specific offset based on a value of the cell common offset minus the first offset increment. For example the terminal device-specific offset may be the value of the cell common offset minus the first offset increment.

In some embodiments, the units of the first offset increment, the cell-level common offset and the terminal device-specific offset may be a slot or a symbol. For example, the first offset increment may be 3 slots; the cell common offset may be 100 slots; and the terminal device-specific offset is a value of the cell common offset minus the first offset increment, and the terminal device-specific offset may be 97 slots. In other embodiments, the unit of the first offset increment, the cell-level common offset or the terminal device-specific offset may be one of or a combination of at least two of: a wireless frame, a subframe, a slot, or a symbol. For example, the first offset increment may be 1 slot and 7 symbols; the cell common offset may be 100 slots; and the terminal device-specific offset is a value of the cell common offset minus the first offset increment, and the terminal device-specific offset may be 98 slots and 7 symbols.

In operation S903, the terminal device determines a time-domain resource position for an uplink transmission of the terminal device according to the terminal device-specific offset.

After the time-domain resource position for the uplink transmission is determined, the terminal device may send the uplink information on the time-domain resource position for the uplink transmission, or send the uplink information on the time-domain resource position for the uplink transmission and at least one time-domain resource position consecutively following the time-domain resource position for the uplink transmission.

The uplink information may include Uplink Control Information (UCI) and/or uplink data information.

In some embodiments, the terminal device may send the uplink information to the network device via the uplink. In other embodiments, the terminal device may send the uplink information to the network device through other device(s). For example, the terminal device may send the uplink information to other device(s) via a sidelink, so that the other device(s) send the uplink information to the network device.

The time-domain resource position for the uplink transmission may include a subframe, a slot or a symbol. For example, the time-domain resource position for the uplink transmission is a slot.

In some embodiments, in a case where the terminal device sends the uplink information by using at least two carriers, the network device may send at least two first offset increments to the terminal device, so that the terminal device may respectively determine at least two terminal device-specific offsets based on the at least two first offset increments and the acquired cell common offset; and then determine time-domain resource positions for uplink transmissions respectively corresponding to the at least two carriers based on the at least two terminal device-specific offsets.

For example, in the case where the terminal device sends the uplink information by using a first carrier and a second carrier, the first offset increment may include a first sub-offset increment corresponding to the first carrier and a second sub-offset increment corresponding to the second carrier. The terminal device may determine a third sub-offset based on the first sub-offset increment and the cell-level common offset; and determine a fourth sub-offset based on the second sub-offset increment and the cell-level common offset. The terminal device-specific offset includes the third sub-offset and the fourth sub-offset. In this way, the terminal device may determine the first sub-time-domain resource position corresponding to the uplink transmission corresponding to the first carrier based on the third sub-offset, and determine the second sub-time-domain resource position corresponding to the uplink transmission corresponding to the second carrier based on the fourth sub-offset. The first sub-time-domain resource position and the second sub-time-domain resource position are included in the time-domain resource position for the uplink transmission.

The network device may configure a first offset increment for each terminal device. For example, the network device may configure a first offset increment for each of different terminal devices based on position information of the different terminal devices. The first offset increments configured for different terminal devices may be the same or different.

In the embodiment of the present disclosure, the terminal device acquires the first offset increment configured by the network device. The terminal device determines the terminal device-specific offset according to the first offset increment and the cell-level common offset. The terminal device determines the time-domain resource position for the uplink transmission of the terminal device according to the terminal device-specific offset. In this way, the time-domain resource position for the uplink transmission is determined according to the terminal device-specific offset, so that the terminal device can determine the time-domain resource position for the uplink transmission, which improves the reliability of the uplink transmission of the terminal device. In addition, since the terminal device-specific offset is determined according to the first offset increment and the cell-level common offset, the terminal device can use the appropriate terminal device-specific offset in time according to the configured first offset increment, and the flexibility of determining the time-domain resource position for the uplink transmission is improved; furthermore, compared with the technology by which the network device directly configures the terminal device-specific offset, the length occupied by the first offset increment is smaller, and the resource consumption of the network device is reduced and the signaling overhead is effectively reduced.

In some embodiments, the first offset increment is an increment between the terminal device-specific offset and the cell-level common offset.

In some embodiments, the operation that the terminal device determines the terminal device-specific offset according to the first offset increment and the cell-level common offset includes: the terminal device determines the terminal device-specific offset according to a sum of the cell-level common offset and the first offset increment.

In other embodiments, the operation that the terminal device determines the terminal device-specific offset according to the first offset increment and the cell-level common offset includes: the terminal device determines the terminal device-specific offset according to a difference between the cell-level common offset and the first offset increment.

In some implementations, the terminal device may determine, in a pre-configured manner, which one of the sum of or the difference between the cell-level common offset and the first offset increment is adopted to determine the terminal device-specific offset. In other embodiments, the network device may indicate whether the sum of or the difference between the cell-level common offset and the first offset increment is to be adopted to determine the terminal device-specific offset.

In some embodiments, the first offset increment may be a negative value or a non-positive value. In other embodiments, the first offset increment is a positive value or a non-negative value.

In some embodiments, the cell-level common offset is transmitted by the network device through broadcasting.

In some embodiments, the cell-level common offset may be included in System Information (SI) or indicated by the SI. In other embodiments, the cell-level common offset may be included in a Synchronization Signal Block (SSB) or indicated by the SSB.

In some embodiments, the first offset increment is transmitted by the network device through dedicated signaling. For example, the first offset increment is configured in terminal device-specific signaling.

In some embodiments, the first offset increment is configured in RRC signaling of the terminal device. In other embodiments, the first offset increment is configured in an MAC CE.

In the embodiment of the present disclosure, in the case where the network device does not configure the first offset increment for the terminal device, the terminal device determines the time-domain resource position for the uplink transmission by using the cell-level common offset; and then sends the uplink information on the time-domain resource position for the uplink transmission. Each time when the network device starts to configure the first offset increment for the terminal device, the terminal device will determine the terminal device-specific offset according to the cell-level common offset and the first offset increment; then determine the time-domain resource position for the uplink transmission by using the terminal device-specific offset; and then send the uplink information on the time-domain resource position for the uplink transmission. That is to say, in the embodiment of the present disclosure, for a first offset increment configured by the network device in each time, the terminal device determines the terminal device-specific offset based on the first offset increment and the cell-level common offset.

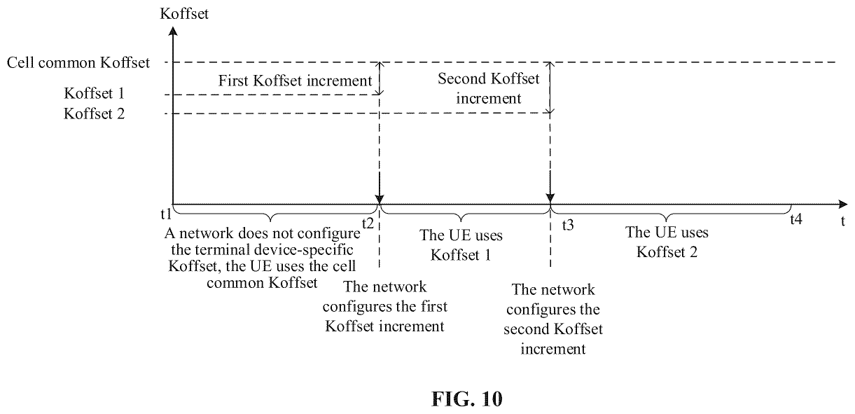

FIG. 10 is a schematic diagram showing determination of a time-domain resource position for an uplink transmission according to an embodiment of the present disclosure. As shown in FIG. 10, a network device configures a first Koffset increment (i.e., a first offset increment) for a terminal device in a connected state. The first Koffset increment is an increment of a terminal device-specific Koffset relative to a cell-level common Koffset (i.e., a cell-level common offset). The terminal device determines the terminal device-specific Koffset based on the cell-level common Koffset and the first Koffset increment. The specific implementation process is as follows.
1. The terminal device in the connected state receives the Koffset configuration information (including or indicating the first offset increment) from the network, where the Koffset configuration information is used for determining the time-domain resource position for the uplink transmission of the terminal device. The time-domain resource position for the uplink transmission is determined based on both of the followings:
a) the cell common Koffset indicated by the network through broadcasting; and
b) the first Koffset increment (corresponding to the first offset increment), the first Koffset increment is an increment of the terminal device-specific Koffset (i.e., the terminal device-specific offset) relative to the cell-level common Koffset (i.e., the cell-level common offset), and the first Koffset increment is configured through terminal device-specific signaling, such as, the terminal device-specific RRC signaling or the MAC CE, etc.
2. In some embodiments, the terminal device determines the terminal device-specific Koffset based on the network configuration by means of: terminal device-specific Koffset=cell common Koffset+first Koffset increment. Exemplarily, the first Koffset increment is a negative value or a non-positive value.

In other embodiments, the terminal device determines the terminal device-specific Koffset based on the network configuration by means of: terminal device-specific Koffset=cell common Koffset−first Koffset increment. Exemplarily, the first Koffset increment is a positive value or a non-negative value.
3. The terminal device determines the time-domain resource position for the uplink transmission of the terminal device by using the terminal device-specific Koffset.

In FIG. 10, the network device does not configure a dedicated offset (or referred to as the UE-specific Koffset) for the terminal device during the period from t1 to t2, and the terminal device determines the time-domain resource position for the uplink transmission by using the cell-level common offset (or referred to as the cell common Koffset), i.e. based on the cell common Koffset. At the moment t2, the network device configures a first Koffset increment for the terminal device, and the terminal device determines a dedicated offset 1 of the terminal device (i.e., Koffset 1) based on the first Koffset increment and the cell common Koffset. During the period from t2 to t3, the terminal device determines the time-domain resource position for the uplink transmission by using the Koffset 1, i.e., based on the dedicated offset 1 of the terminal device. At the moment t3, the network device configures a new first Koffset increment for the terminal device, and the terminal device determines a dedicated offset 2 of the terminal device (i.e., Koffset 2) based on the new first Koffset increment and the cell common Koffset. During the period from t3 to t4, the terminal device determines the time-domain resource position for the uplink transmission by using the Koffset 2, i.e., based on the dedicated offset 2 of the terminal device.

In some embodiments, the terminal device may adjust the terminal device-specific offset and determine the time-domain resource position for the uplink transmission of the terminal device based on an adjusted terminal device-specific offset. For example, in some embodiments, the terminal device may determine the adjusted terminal device-specific offset based on the terminal device-specific offset.

In some embodiments, the terminal device may obtain a second offset increment configured by the network device, and determine the adjusted terminal device-specific offset based on the terminal device-specific offset and the second offset increment.

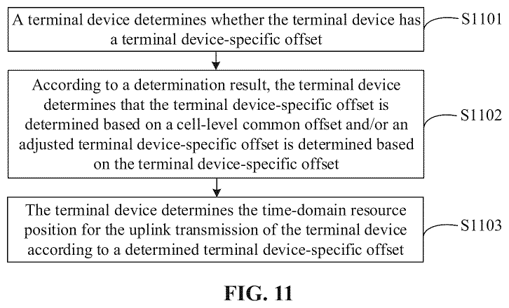

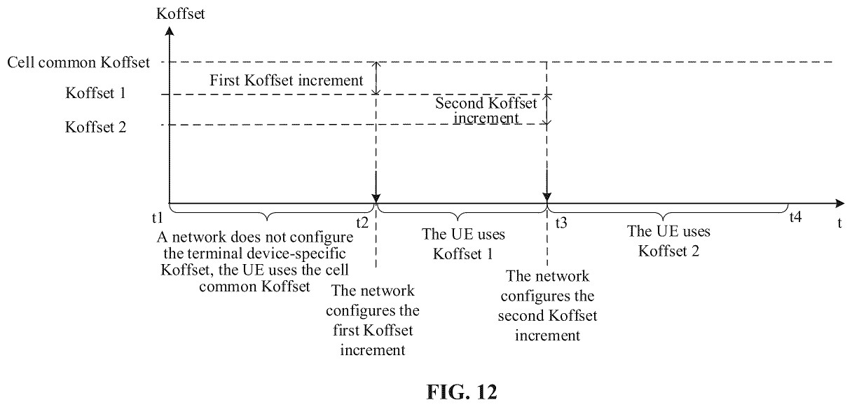

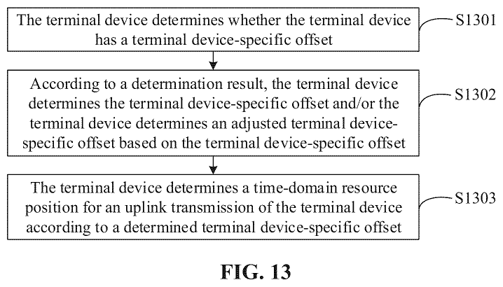

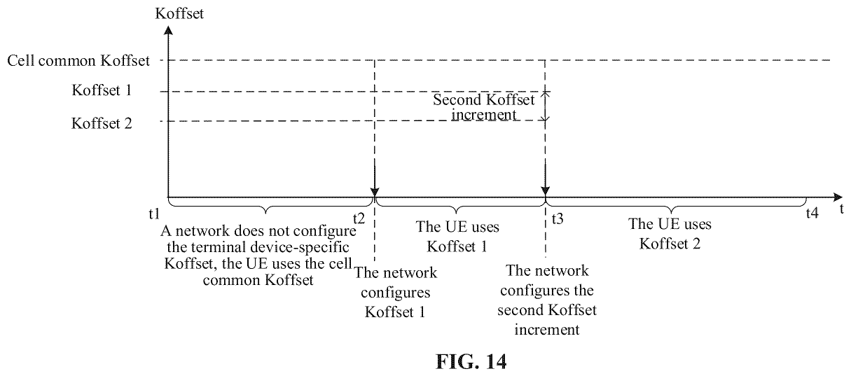

The implementation corresponding to FIG. 11 to FIG. 12 and the implementation corresponding to FIG. 13 to FIG. 14 respectively illustrate two implementations for determining the adjusted terminal device-specific offset based on the terminal device-specific offset.

FIG. 11 is a flowchart of a communication method according to another embodiment of the present disclosure. As shown in FIG. 11, the method is applied to a terminal device or a processor in the terminal device. The method includes following operations S1101 to S1103.

In operation S1101, a terminal device determines whether the terminal device has a terminal device-specific offset.

In some embodiments, the terminal device may determine whether the terminal device-specific offset is stored in the terminal device, to determine whether the terminal device has the terminal device-specific offset. In a case where the terminal device-specific offset is stored, it is determined that the terminal device has the terminal device-specific offset. In a case where the terminal device-specific offset is not stored, it is determined that the terminal device does not have the terminal device-specific offset.

In other embodiments, the terminal device may determine whether the currently used offset is a common offset, to determine whether the terminal device has the terminal device-specific offset. In a case where the offset currently used by the terminal device is the terminal device-specific offset, it is determined that terminal device has the terminal device-specific offset. In a case where the offset currently used by the terminal device is the common offset, it is determined that the terminal device does not have the terminal device-specific offset.

The terminal device-specific offset is different from the cell-level common offset. The terminal device-specific offset may be determined based on a transmission delay between the terminal device and the network device. The transmission delay between the terminal device and the network device may be associated with a distance between the terminal device and the network device.

The terminal device may determine whether the terminal device has the terminal device-specific offset in a case where the terminal device receives an offset increment sent by the network device. The offset increment sent by the network device may be the first offset increment or the second offset increment.

In still other embodiments, the network device may instruct the terminal device to determine the time-domain resource position for the uplink transmission by using the offset increment and the cell-level common offset, or by using the offset increment and the terminal device-specific offset. In the case where the network device instructs the terminal device to determine the time-domain resource position for the uplink transmission by using the offset increment and the cell-level common offset, it is determined that the terminal device does not have the terminal device-specific offset. In a case where the network device instructs the terminal device to determine the time-domain resource position for the uplink transmission by using the offset increment and the terminal device-specific offset, it is determined that the terminal device has the terminal device-specific offset.

The dedicated offsets of different terminal devices may be different or the same.

In operation S1102, according to a determination result, the terminal device determines that the terminal device-specific offset is determined based on a cell-level common offset and/or an adjusted terminal device-specific offset is determined based on the terminal device-specific offset.

The determination result may include having the terminal device-specific offset or not having the terminal device-specific offset.

In operation S1103, the terminal device determines a time-domain resource position for the uplink transmission of the terminal device according to a determined terminal device-specific offset.

The determined terminal device-specific offset may be a latest determined terminal device-specific offset. For example, the terminal device-specific offset determined based on the cell-level common offset is determined as the latest determined terminal device-specific offset. Alternatively, the adjusted terminal device-specific offset is the latest determined terminal device-specific offset.

The operation S1103 may be implemented with reference to the related description of the operation S903, which will not be repeated herein.

In some embodiments, after the operation S1103, the terminal device will have the terminal device-specific offset, such that after the operation S1103, the terminal device may determine the adjusted terminal device-specific offset based on the terminal device-specific offset; and determine the time-domain resource position for the uplink transmission of the terminal device according to the adjusted terminal device-specific offset.

In some embodiments, the operation that the terminal device determines that the terminal device-specific offset is determined based on the cell-level common offset and/or the adjusted terminal device-specific offset is determined based on the terminal device-specific offset includes: in a case where the terminal device does not have the terminal device-specific offset, the terminal device determines the terminal device-specific offset according to the cell-level common offset and a first offset increment.

In other embodiments, the operation that the terminal device determines that the terminal device-specific offset is determined based on the cell-level common offset and/or the adjusted terminal device-specific offset is determined based on the terminal device-specific offset includes: in a case where the terminal device has the terminal device-specific offset, the terminal device determines the adjusted terminal device-specific offset according to the terminal device-specific offset and a second offset increment.

The first offset increment is used for changing the cell-level common offset. The second offset increment is used for changing the terminal device-specific offset.

In some embodiments, in the case where the terminal device has the terminal device-specific offset, the operation that the terminal device determines the adjusted terminal device-specific offset according to the terminal device-specific offset and the second offset increment includes:
the terminal device acquires the second offset increment configured by the network device, where the second offset increment is an increment between the terminal device-specific offset and the adjusted terminal device-specific offset; and
the terminal device determines the adjusted terminal device-specific offset according to the terminal device-specific offset and the second offset increment.

The implementations in which the terminal device acquires the second offset increment configured by the network device may include: the terminal device receives the second offset increment sent by the network device.

In some embodiments, the operation that the terminal device determines the adjusted terminal device-specific offset according to the terminal device-specific offset and the second offset increment includes: the terminal device determines the adjusted terminal device-specific offset according to a sum of the terminal device-specific offset and the second offset increment.

In other embodiments, the operation that the terminal device determines the adjusted terminal device-specific offset according to the terminal device-specific offset and the second offset increment includes: the terminal device determines the adjusted terminal device-specific offset according to a difference between the terminal device-specific offset and the second offset increment.

In some implementations, the terminal device may determine which one of the sum of or the difference between terminal device-specific offset and the second offset increment is adopted to determine the terminal device-specific offset in a pre-configured manner. In other embodiments, the network device may indicate whether the sum of or the difference between the terminal device-specific offset and the second offset increment is to be adopted to determine the terminal device-specific offset.

The difference between the terminal device-specific offset and the second offset increment may be a result of the terminal device-specific offset minus the second offset increment.

In some embodiments, the second offset increment may be a negative value or a non-positive value. In other embodiments, the second offset increment is a positive value or a non-negative value.

In some embodiments, the second offset increment is transmitted by the network device through dedicated signaling. For example, the second offset increment is configured in the dedicated signaling of the terminal device.

In some embodiments, in the case where the terminal device does not have the terminal device-specific offset, the operation that the terminal device determines the terminal device-specific offset according to the cell-level common offset and the first offset increment includes:
the terminal device acquires the first offset increment configured by the network device, where the first offset increment is an increment between the terminal device-specific offset and the cell-level common offset of the terminal device; and
the terminal device determines the terminal device-specific offset according to the cell-level common offset and the first offset increment.

The implementation in which the terminal device acquires the first offset increment configured by the network device may include: the terminal device receives the first offset increment sent by the network device.

In some embodiments, the operation that the terminal device determines the terminal device-specific offset according to the cell-level common offset and the first offset increment includes: the terminal device determines the terminal device-specific offset according to a sum of the cell-level common offset and the first offset increment.

In some embodiments, the operation that the terminal device determines the terminal device-specific offset according to the cell-level common offset and the first offset increment includes: the terminal device determines the terminal device-specific offset according to a difference between the cell-level common offset and the first offset increment.

The difference between the cell-level common offset and the first offset increment may be a result of the cell-level common offset minus the first offset increment.

In some embodiments, the first offset increment is transmitted by the network device through dedicated signaling. For example, the first offset increment is configured in the dedicated signaling of the terminal device.

In some embodiments, the first offset increment and/or the second offset increment are configured in the RRC signaling of the terminal device. In other embodiments, the first offset increment and/or the second offset increment are configured in an MAC CE.

In the embodiment of the present disclosure, in the case where the network device does not configure the first offset increment for the terminal device, the terminal device determines the time-domain resource position for the uplink transmission by using the cell-level common offset; and then sends the uplink information on the time-domain resource position for the uplink transmission. In the case where the terminal device receives the first offset increment configured by the network device, the terminal device will determine the terminal device-specific offset according to the cell-level common offset and the first offset increment; then determine the time-domain resource position for the uplink transmission by using the terminal device-specific offset; and then send the uplink information on the time-domain resource position for the uplink transmission. In this way, the terminal device has the terminal device-specific offset. After that, each time when the network device configures the second offset increment for the terminal device, the terminal device will determine the adjusted terminal device-specific offset according to the terminal device-specific offset and the second offset increment; then determine the time-domain resource position for the uplink transmission by using the adjusted terminal device-specific offset; and then send the uplink information on the time-domain resource position for the uplink transmission.

That is to say, in the embodiment of the present disclosure, for the first offset increment configured by the network device, the terminal device determines the terminal device-specific offset based on the first offset increment and the cell-level common offset. For second offset increment configured by the network device in each time, the terminal device determines the adjusted terminal device-specific offset based on the second offset increment and the terminal device-specific offset. In the case where the terminal device does not have the terminal device-specific offset, the time-domain resource position for the uplink transmission is determined by using the cell-level common offset. In the case where the terminal device has the terminal device-specific offset, the time-domain resource position for the uplink transmission is determined by using the latest obtained terminal device-specific offset.

FIG. 12 is schematic diagram showing determination of a time-domain resource position for an uplink transmission according to another embodiment of the present disclosure. As shown in FIG. 12, the network device configures a Koffset increment (a first offset increment or a second offset increment) for the terminal device in the connected state, and the Koffset increment is an increment of an adjusted terminal device-specific Koffset relative to a cell-level common Koffset (i.e., a cell-level common offset) (if the terminal device does not currently have the terminal device-specific Koffset). Alternatively, the Koffset increment is an adjustment amount of the adjusted terminal device-specific Koffset (i.e., the first dedicated offset of the terminal device) relative to the terminal device-specific Koffset (if the terminal device currently has the terminal device-specific Koffset). The terminal device determines the adjusted terminal device-specific Koffset based on the cell-level common Koffset/the terminal device-specific Koffset, and based on the Koffset increment. The specific implementation process is as follows.
1. The terminal device in the connected state receives the Koffset configuration information (including or indicating the first offset increment) sent by the network, where the Koffset configuration information is used for determining the time-domain resource position for the uplink transmission of the terminal device. The time-domain resource position for the uplink transmission is determined based on both of the followings:
a) the cell common Koffset indicated by the network through broadcasting; and
b) the Koffset increment, configured by terminal device-specific signaling, such as, terminal device-specific RRC signaling or an MAC CE, etc.
2. The terminal device determines the terminal device-specific Koffset based on network configuration through the following ways.
a) In some embodiments, if the terminal device does not have an available terminal device-specific Koffset before the terminal device receives signaling indicating the first Koffset increment (e.g. the network device does not configure the terminal device-specific Koffset for the terminal device, or the terminal device does not determine the terminal device-specific Koffset based on the cell-level common offset), the terminal device determines the terminal device-specific Koffset based on the cell-level common Koffset and the first Koffset increment. That is to say, the terminal device-specific Koffset=cell-level common Koffset+first Koffset increment, where, exemplarily, the first Koffset increment is a negative value or a non-positive value. Alternatively, the terminal device-specific Koffset=cell-level common Koffset−first Koffset increment, where, exemplarily, the first Koffset increment is a positive value or a non-negative value.
b) In other embodiments, if the terminal device has an available terminal device-specific Koffset before the terminal device receives signaling indicating the second Koffset increment (second offset increment) (e.g. the network device configures the terminal device-specific Koffset for the terminal device, or the terminal device determines the terminal device-specific Koffset based on the cell-level common offset/terminal device-specific Koffset), the terminal device determines the adjusted terminal device-specific Koffset based on the current terminal device-specific Koffset and the second Koffset increment. That is to say, the terminal device-specific Koffset=terminal device-specific Koffset+second Koffset increment; or, the terminal device-specific Koffset=terminal device-specific Koffset−second Koffset increment. In such an embodiment, the second Koffset increment may be 0, positive or negative.

The terminal device determines the time-domain resource position for the uplink transmission of the terminal device by using the latest obtained terminal device-specific Koffset.

As shown in FIG. 12, during the period from t1 to t2, the network device does not configure the dedicated offset (or referred to as the UE-specific Koffset) for the terminal device, and the terminal device determines the time-domain resource position for the uplink transmission by using the cell-level common offset (or referred to as the cell common Koffset), i.e. based on the cell common Koffset. At the moment t2, the network device configures a first Koffset increment for the terminal device, and the terminal device determines a dedicated offset 1 (i.e., Koffset 1) of the terminal device based on the first Koffset increment and the cell common Koffset. During the period from t2 to t3, the terminal device determines the time-domain resource position for the uplink transmission by using the dedicated offset 1, i.e., based on the dedicated offset 1 of the terminal device. At the moment t3, the network device configures a second Koffset increment for the terminal device, and the terminal device determines a dedicated offset 2 (i.e., Koffset 2) of the terminal device based on the second Koffset increment and Koffset 1. During the period from t3 to t4, the terminal device determines the time-domain resource position for the uplink transmission by using the Koffset 2, i.e., based on the dedicated offset 2 of the terminal device.

FIG. 13 is a flowchart of a communication method according to another embodiment of the present disclosure. As shown in FIG. 13, the method is applied to a terminal device or a processor in the terminal device. The method includes following operations S1301 to S1303.

In operation S1301, the terminal device determines whether the terminal device has a terminal device-specific offset.

The operation S1301 may be implemented with reference to the related description of the operation S1101, which will not be repeated herein.

In operation S1302, according to a determination result, the terminal device determines the terminal device-specific offset and/or the terminal device determines an adjusted terminal device-specific offset based on the terminal device-specific offset.

The determination result may include having the terminal device-specific offset or not having the terminal device-specific offset.

In some embodiments, the operation that the terminal device determines the terminal device-specific offset may include: the terminal device receives the terminal device-specific offset configured by the network device-.

In operation S1303, the terminal device determines a time-domain resource position for an uplink transmission of the terminal device according to a determined terminal device-specific offset.

The determined terminal device-specific offset may be a latest determined terminal device-specific offset. For example, the terminal device-specific offset determined by the terminal device according to the determination result is the latest determined terminal device-specific offset; or, the adjusted terminal device-specific offset is the latest determined terminal device-specific offset.

The operation S1303 may be implemented with reference to the related description of the operation S903, which will not be repeated herein.

In some embodiments, after the operation S1303, the terminal device will have the terminal device-specific offset, such that after the operation S1303, the terminal device may determine the adjusted terminal device-specific offset based on the terminal device-specific offset; and determine the time-domain resource position for the uplink transmission of the terminal device according to the adjusted terminal device-specific offset.

In some embodiments, that operation that the terminal device determines the terminal device-specific offset and/or the terminal device determines the adjusted terminal device-specific offset based on the terminal device-specific offset includes: in a case where the terminal device does not have the terminal device-specific offset, the terminal device acquires the terminal device-specific offset.

In other embodiments, that operation that the terminal device determines the terminal device-specific offset and/or the terminal device determines the adjusted terminal device-specific offset based on the terminal device-specific offset includes: in a case where the terminal device has the terminal device-specific offset, the terminal device determines the adjusted terminal device-specific offset according to the terminal device-specific offset and a second offset increment, where the second offset increment is an increment between the terminal device-specific offset and the adjusted terminal device-specific offset.

In some embodiments, the operation that the terminal device determines the adjusted terminal device-specific offset according to the terminal device-specific offset and the second offset increment includes: the terminal device determines the terminal device-specific offset according to a sum of the terminal device-specific offset and the second offset increment.

In other embodiments, the operation that the terminal device determines the adjusted terminal device-specific offset according to the terminal device-specific offset and the second offset increment includes: the terminal device determines the terminal device-specific offset according to a difference between the terminal device-specific offset and the second offset increment.

In some embodiments, the method further includes: the terminal device acquires first signaling configured by the network device, where the first signaling is used for configuring the terminal device-specific offset.

In other embodiments, the method further includes: the terminal device acquires second signaling configured by the network device, where the second signaling is used for configuring the second offset increment.

In some embodiments, the first signaling may include a first MAC CE and the second signaling may include a second MAC CE. A format of the first MAC CE is different a format of the second MAC CE. The format of the MAC CE may include a long format, a short format, a fixed length format and a variable length format. The format of the first MAC CE and the format of the second MAC CE may be selected from the long format, the short format, the fixed length format, and the variable length format. For example, in some embodiments, the format of the first MAC CE is the long format and the format of the second MAC CE is the short format. In other embodiments, the format of the first MAC CE is the fixed length format or the variable length format, and the format of the second MAC CE is the variable length format or the fixed length format. In still other embodiments, the format of the first MAC CE may be a combination of the long format and the fixed length format, and the format of the second MAC CE may be a combination of the short format and the fixed length format. In still other embodiments, the format of the first MAC CE may be a combination of the long format and the variable length format, and the format of the second MAC CE may be a combination of the short format and the fixed length format. The manners for determining the format of the first MAC CE and the format of the second MAC CE are not limited in the embodiments of the present disclosure.

A bit length (or referred to as the number of bits or the payload length) used for setting the offset in the long format is greater than a bit length used for setting the offset in the short format. For example, the bit length for setting the offset in the long format may be greater than a first target value and less than or equal to a second target value, and the bit length for setting the offset in the short format may be greater than or equal to 1 and less than or equal to the first target value.

The bit length for setting the offset in the fixed length format is fixed. The bit length for setting the offset in the variable length format is variable.

In some embodiments, the format of the MAC CE may further include a first indicator for indicating the bit length of the offset. For example, in the case where the first indicator indicates 5, it indicates that the bit length for setting the offset in the MAC CE is 5.

In some embodiments, the first signaling includes the long MAC CE and the second signaling includes the short MAC CE. The long MAC CE has a payload length greater than a payload length of the short MAC CE.

In some embodiments, the first signaling includes dedicated RRC signaling and the second information includes the MAC CE. In this way, the terminal device determines that the network device sends the terminal device-specific offset according to the received signaling being the RRC signaling. The terminal device determines that the network device sends the second offset increment according to the received signaling being the MAC CE.

In the embodiment of the present disclosure, in the case where the network device does not configure the dedicated offset of the terminal device, the terminal device determines the time-domain resource position for the uplink transmission by using the cell-level common offset; and then sends the uplink information on the time-domain resource position for the uplink transmission. In the case where the terminal device receives the dedicated offset of the terminal device configured by the network device, the terminal device has the terminal device-specific offset, the terminal device determines the adjusted terminal device-specific offset according to the terminal device-specific offset and the second offset increment; then determines the time-domain resource position for the uplink transmission by using the adjusted terminal device-specific offset; and then sends the uplink information on the time-domain resource position for the uplink transmission. After that, each time when the network device configures the second offset increment for the terminal device, the terminal device will determine the adjusted terminal device-specific offset according to the terminal device-specific offset and the second offset increment; then determine the time-domain resource position for the uplink transmission by using the adjusted terminal device-specific offset; and then send the uplink information on the time-domain resource position for the uplink transmission.

For the second offset increment configured by the network device in each time, the terminal device determines the adjusted terminal device-specific offset based on the second offset increment and the terminal device-specific offset. In the case where the terminal device does not have the terminal device-specific offset, the terminal device receives the terminal device-specific offset configured by the network device. In the case where the terminal device has the terminal device-specific offset, the terminal device determines the time-domain resource position for the uplink transmission by using the latest obtained terminal device-specific offset.

FIG. 14 is a schematic diagram showing determination of a time-domain resource position for an uplink transmission according to an embodiment of the present disclosure. As shown in FIG. 14, if the terminal device in the connected state does not currently have the terminal device-specific Koffset, the network device configures the terminal device-specific Koffset or an absolute value of the terminal device-specific Koffset for the terminal device in the connected state.

If the terminal device in the connected state currently has the terminal device-specific Koffset, the network device configures a second Koffset increment for the terminal device in the connected state. The second Koffset increment is the adjustment amount of the adjusted terminal device-specific Koffset relative to the current terminal device-specific Koffset, and the terminal device determines the adjusted terminal device-specific Koffset based on the second Koffset increment.

The specific implementation process is as follows.
1. The terminal device in the connected state receives the specific Koffset configuration information (including or indicating the first offset increment) sent by the network, where the specific Koffset configuration information is used for determining the time-domain resource position for the uplink transmission of the terminal device.
a) The configuration information of the terminal device-specific Koffset may be used for indicating the absolute value of the terminal device-specific Koffset, or the second Koffset increment. The second Koffset increment is the adjustment amount of the adjusted terminal device-specific Koffset relative to the current terminal device-specific Koffset.
b) The configuration information of the terminal device-specific Koffset is configured through terminal device-specific signaling, such as terminal device-specific RRC signaling or an MAC CE, etc.

In some embodiments, if the terminal device-specific Koffset is configured by using the MAC CE, for the case of configuring the “absolute value of the terminal device-specific Koffset” and the case of configuring the “second Koffset increment”, different MAC CE formats are used. For example, a long MAC CE format (i.e., an MAC CE payload size corresponding to the Long MAC CE is larger) is defined to configure the “terminal device-specific Koffset or absolute value of the terminal device-specific Koffset”; and a short MAC CE format (i.e., an MAC CE payload size corresponding to the Short MAC CE is smaller) is defined to configure the “second Koffset increment”.

In this way, the network can configure the “second Koffset increment” by using the short MAC CE format only in a case where the terminal device currently has the available terminal device-specific Koffset (for example, the network device configures the terminal device-specific Koffset for the terminal device, or the terminal device-specific Koffset is determined based on the cell-level common offset).

In other embodiments, the absolute value of the terminal device-specific Koffset is configured by using the RRC signaling, and the second Koffset increment is configured by using the MAC CE.
2. The terminal device may determine the terminal device-specific Koffset based on the network configuration.
a) Exemplarily, for the case where the terminal device-specific Koffset is configured by using the MAC CE,
if the terminal device receives the first MAC CE, the terminal device-specific Koffset or the absolute value of the terminal device-specific Koffset indicated by the first MAC CE is taken as the terminal device-specific Koffset; and
if the terminal device receives the second MAC CE, the terminal device determines the adjusted terminal device-specific Koffset according to the current terminal device-specific Koffset and the second Koffset increment indicated by the second MAC CE. That is to say, terminal device-specific Koffset=terminal device-specific Koffset+second Koffset increment; alternatively, terminal device-specific Koffset=terminal device-specific Koffset−second Koffset increment. In such an embodiment, the second Koffset increment may be 0, positive or negative.
b) Exemplarily, for the case where the terminal device-specific Koffset is configured by using terminal device-specific RRC signaling and the MAC CE,
if the terminal device receives the terminal device-specific RRC signaling used for configuring the terminal device-specific Koffset, the terminal device-specific Koffset indicated by the RRC signaling is taken as the terminal device-specific Koffset; and
if the terminal device receives the MAC CE used for configuring the terminal device-specific Koffset (i.e. the second Koffset increment), the terminal device determines the adjusted terminal device-specific Koffset according to the current terminal device-specific Koffset and the second Koffset increment indicated by the MAC CE. That is to say, terminal device-specific Koffset=terminal device-specific Koffset+the second Koffset increment; alternatively, terminal device-specific Koffset=terminal device-specific Koffset−the second Koffset increment.

The terminal device determines the time-domain resource position for the uplink transmission of the terminal device by using the terminal device-specific Koffset.

As shown in FIG. 14, during the period from t1 to t2, the network device does not configure the dedicated offset (or the UE-specific Koffset) for the terminal device, and the terminal device determines the time-domain resource position for the uplink transmission by using the cell-level common offset (or referred to as the cell common Koffset), i.e. based on the cell common Koffset. At the moment t2, the network device configures the terminal device-specific Koffset or the absolute value of the terminal device-specific Koffset for the terminal device (the network configures Koffset 1); and the terminal device determines the terminal device-specific Koffset or the absolute value of the terminal device-specific Koffset as a dedicated offset 1 (i.e., Koffset 1) of the terminal device. During the period from t2 to t3, the terminal device determines the time-domain resource position for the uplink transmission by using the dedicated offset 1 of the terminal device, i.e., based on the dedicated offset 1 of the terminal device. At the moment t3, the network device configures a second Koffset increment for the terminal device. The terminal device determines a dedicated offset 2 (i.e., Koffset 2) of the terminal device based on the second Koffset increment and the Koffset 1. During the period from t3 to t4, the terminal device determines the time-domain resource position for the uplink transmission by using the Koffset 2, i.e., based on the dedicated offset 2 of the terminal device.

A communication method at the network device side corresponding to FIG. 9 to FIG. 10 will be described below, and operations thereof identical to or corresponding to the operations performed by the terminal device may be understood with reference to the description for the terminal device.

The communication method provided by the embodiment of the present disclosure is applied to a network device or a processor in the network device. The method includes:
the network device configures a first offset increment for a terminal device;
the network device determines a terminal device-specific offset according to the first offset increment and a cell-level common offset; and
the network device determines a time-domain resource position for an uplink
transmission of the terminal device according to the terminal device-specific offset.

In some embodiments, the first offset increment is an increment between the terminal device-specific offset and the cell-level common offset.

In some embodiments, the operation that the network device determines the terminal device-specific offset according to the first offset increment and the cell-level common offset includes:
the network device determines the terminal device-specific offset according to a sum of the cell-level common offset and the first offset increment; or
the network device determines the terminal device-specific offset according to a difference between the cell-level common offset and the first offset increment.

In some embodiments, the cell-level common offset is transmitted by the network device through broadcasting.

In some embodiments, the first offset increment is transmitted by the network device through dedicated signaling.

A communication method at the network device side corresponding to FIG. 11 to FIG. 12 will be described below, and operations thereof identical to or corresponding to the operations performed by the terminal device may be understood with reference to the description for the terminal device.

The communication method provided by the embodiment of the present disclosure is applied to a network device or a processor in the network device. The method includes:
the network device determines whether a terminal device has a terminal device-specific offset;
the network device determines, according to a determination result, that the terminal device-specific offset is determined based on a cell-level common offset or an adjusted terminal device-specific offset is determined based on the terminal device-specific offset; and
the network device determines a time-domain resource position for an uplink transmission of the terminal device according to a determined terminal device-specific offset.

In some embodiments, the operation that the network device determines, according to the determination result, that the terminal device-specific offset is determined based on the cell-level common offset or the adjusted terminal device-specific offset is determined based on the terminal device-specific offset includes:
in a case where the terminal device does not have the terminal device-specific offset, the network device determines the terminal device-specific offset according to the cell-level common offset and a first offset increment; and
in a case where the terminal device has the terminal device-specific offset, the network device determines the adjusted terminal device-specific offset according to the terminal device-specific offset and a second offset increment.

In some embodiments, the operation that in the case where the terminal device has the terminal device-specific offset, the network device determines the adjusted terminal device-specific offset according to the terminal device-specific offset and the second offset increment includes:
the network device configures the second offset increment for the terminal device, where the second offset increment is an increment between the terminal device-specific offset and the adjusted terminal device-specific offset; and
the network device determines the adjusted terminal device-specific offset according to the terminal device-specific offset and the second offset increment.

In some embodiments, the operation that the network device determines the adjusted terminal device-specific offset according to the terminal device-specific offset and the second offset increment includes:
the network device determines the adjusted terminal device-specific offset according to a sum of the terminal device-specific offset and the second offset increment; or
the network device determines the adjusted terminal device-specific offset according to a difference between the terminal device-specific offset and the second offset increment.

In some embodiments, the second offset increment is transmitted by the network device through dedicated signaling.

In some embodiments, the operation that in the case where the terminal device does not have the terminal device-specific offset, the network device determines the terminal device-specific offset according to the cell-level common offset and the first offset increment includes:
the network device configures the first offset increment for the terminal device, where the first offset increment is an increment between the terminal device-specific offset and the cell-level common offset of the terminal device; and
the network device determines the terminal device-specific offset according to the cell-level common offset and the first offset increment.

In some embodiments, the operation that the network device determines the terminal device-specific offset according to the cell-level common offset and the first offset increment includes:
the network device determines the terminal device-specific offset according to a sum of the cell-level common offset and the first offset increment; or
the network device determines the terminal device-specific offset according to a difference between the cell-level common offset and the first offset increment.

In some embodiments, the first offset increment is transmitted by the network device through dedicated signaling.

A communication method at the network device side corresponding to FIG. 13 to FIG. 14 will be described below, and operations thereof identical to or corresponding to the operations performed by the terminal device may be understood with reference to the description for the terminal device.

The communication method provided by the embodiment of the present disclosure is applied to a network device or a processor in the network device. The method includes:
the network device determines whether a terminal device has a terminal device-specific offset;
the network device determines, according to a determination result, the terminal device-specific offset and/an adjusted terminal device-specific offset based on the terminal device-specific offset; and
the network device determines a time-domain resource position for an uplink transmission of the terminal device according to a determined terminal device-specific offset.

In some embodiments, the operation that the network device determines, according to the determination result, the terminal device-specific offset and/or the adjusted terminal device-specific offset based on the terminal device-specific offset includes:
in a case where the terminal device does not have the terminal device-specific offset, the network device acquires, the terminal device-specific offset; and
in a case where the terminal device has the terminal device-specific offset, the network device determines the adjusted terminal device-specific offset according to the terminal device-specific offset and a second offset increment, where the second offset increment is an increment between the terminal device-specific offset and the adjusted terminal device-specific offset.

In some embodiments, the operation that the network device determines the adjusted terminal device-specific offset according to the terminal device-specific offset and the second offset increment includes:
the network device determines the terminal device-specific offset according to a sum of the terminal device-specific offset and the second offset increment; or
the network device determines the terminal device-specific offset according to a difference between the terminal device-specific offset and the second offset increment.

In some embodiments, the method further includes:
the network device configures first signaling for the terminal device, where the first signaling is used for configuring an terminal device-specific offset, and/or
the network device configures second signaling for the terminal device, where the second signaling is used for configuring the second offset increment.

In some embodiments, the first signaling includes a long MAC CE and the second signaling includes a short MAC CE, the long MAC CE having a payload length greater than a payload length of the short MAC CE.

In some embodiments, the first signaling includes dedicated RRC signaling and the second information includes an MAC CE.

Herein, the implementation of determining the time-domain resource position for the uplink transmission of the terminal device according to the terminal device-specific offset is explained by taking the time-domain resource position for the uplink transmission including slots as an example. The implementation may be applied to any of the above embodiments. For example, the implementation may be applied to the operation S903, operation S1103 or operation S1303, and/or the operation at the network device side corresponding to operation S903, operation S1103 or operation S1303.

In some embodiments, in a case where the terminal device is scheduled by Downlink Control Information (DCI) received at a slot n to send a Physical Uplink Shared Channel (PUSCH), the slot for transmitting the PUSCH or the slot for transmitting Channel State Information (CSI) on the PUSCH is

$$⌊ n \cdot \frac{{2}^{{μ}_{PUSCH}}}{{2}^{{μ}_{PDCCH}}} ⌋ + {K}_{2} + {K}_{offset} .$$

K₂ is determined based on a subcarrier spacing of the PUSCH.

μ_{PUSCH} is used for determining a subcarrier spacing configured for a Physical Downlink Share Channel (PDSCH).

μ_{PUSCH} is used for determining a subcarrier spacing configured for a Physical Downlink Control Channel (PDCCH).

K_{offset} is the terminal device-specific offset. In the embodiment of the present disclosure, K_{offset} may also be understood as Koffset.

K₂ has a value range from 0 to 32. Indication information of K₂ may be included in the DCI, and K₂ is used for determining a slot for transmitting the PUSCH.

In some embodiments, after the terminal device initiates a Physical Random Access Channel (PRACH) and in a case where an end position where the terminal device receives the PDSCH including a random access response grant is a slot n, then the slot for transmitting the PUSCH is n+K₂+Δ+K_{offset}.

K₂ and Δ are predefined by protocol.

K_{offset} is the terminal device-specific offset.

In some embodiments, the first time-domain resource position includes a slot.

In a case where the end position where the terminal device receives the PDSCH is the slot n or an end position where the terminal device receives a PDCCH indicating Semi-Persistent Scheduling (SPS) PDSCH release is the slot n, the terminal device transmits Hybrid Automatic Repeat request-ACKnowledge (HARQ-ACK) information on a Physical Uplink Control Channel (PUCCH) resource in the slot n+K₁+K_{offset}.

K₁ is determined based on PDSCH-to-HARQ-timing-indicator or K₁ is determined based on dl-Data ToUL-ACK.

K_{offset} is the terminal device-specific offset.

In such an embodiment, for the slot for transmitting the PUCCH, if the end position where the PDSCH is received is in the slot n or the end position where the PDCCH indicating the SPS PDSCH release is received is in the slot n, the UE should transmit the corresponding HARQ-ACK information on PUCCH resource within the slot n+K₁+K_{offset}. K₁ is the number of slots and is indicated by the information field PDSCH-to-HARQ-timing-indicator in the DCI format or provided by the parameter dl-DataToUL-ACK. K₁=0 corresponds to the case where the last slot for transmitting the PUCCH overlaps with the slot when the PDSCH is received or the slot when the PDCCH indicating the SPS PDSCH release is received.

In some embodiments, in the case where HARQ-ACK information corresponding to a PDSCH including an MAC CE command is transmitted in the slot n, a behavior indicated by the MAC CE command and/or a downlink configuration of the terminal device takes effect at a first one slot following the slot n+X×Nₛₗₒₜ^{subframe,μ}+K_{offset}.

X is determined based on a capability of the terminal device in the NTN; and a value of X may not be 3.

Nₛₗₒₜ^{subframe,μ} is the number of slots included in each subframe under a subcarrier spacing configuration μ.

K_{offset} is the terminal device-specific offset.

In some embodiments, the slot n′ for reporting the CSI on the CSI reference resource is determined based on slot n−n_{CSI}_{_{ref}}−K_{offset}.

$$n = ⌊ {n}^{′} \cdot \frac{{2}^{{μ}_{DL}}}{{2}^{{μ}_{UL}}} ⌋ ; {μ}_{DL}$$

is determined based on a downlink subcarrier spacing; and μ_{UL} is determined based on an uplink subcarrier spacing.

n_{CSI_ref} is determined based on a type of a CSI report.

K_{offset} is the terminal device-specific offset.

In such an embodiment, the CSI reference resource for reporting the CSI in an uplink slot n′ is determined according to a single downlink slot n−n_{CSI}_{_{ref}}−K_{offset}. Herein,

$$n = ⌊ {n}^{′} \cdot \frac{{2}^{{μ}_{DL}}}{{2}^{{μ}_{UL}}} ⌋ ,$$

where μ_{DL} and μ_{UL} are respectively the downlink subcarrier spacing configuration and the uplink subcarrier spacing configuration. A value of n_{CSI_ref} depends on the type of the CSI report.

In some embodiments, in a case where the terminal device receives, in the slot n, DCI that triggers transmission of an aperiodic Sounding Reference Signal (SRS), the terminal device transmits the aperiodic SRS in each triggered SRS resource set in a slot

$$⌊ n \cdot \frac{{2}^{{μ}_{PUSCH}}}{{2}^{{μ}_{PDCCH}}} ⌋ + {K}_{2} + {K}_{offset} .$$

k is determined based on a high-layer parameter slotOffset in each triggered SRS resource set and a subcarrier spacing corresponding to the triggered SRS transmission.

μ_{SRS} is determined based on the subcarrier spacing of the triggered SRS.

μ_{PUSCH} is determined based on the subcarrier spacing of the PDCCH carrying a trigger command.

K_{offset} is the terminal device-specific offset.

In such an embodiment, if the UE receives, in the slot n, the DCI that triggers transmission of an aperiodic SRS, the UE transmits the aperiodic SRS in each triggered SRS resource set in the slot

$$⌊ n \cdot \frac{{2}^{{μ}_{PUSCH}}}{{2}^{{μ}_{PDCCH}}} ⌋ + {K}_{2} + {K}_{offset} .$$

Herein, k is configured by the high-layer parameter slotOffset in each triggered SRS resource set and determined according to the subcarrier spacing corresponding to the triggered SRS transmission. μ_{SRS} and μ_{PUSCH} are respectively the subcarrier spacing of the triggered SRS and the subcarrier spacing of the PDCCH carrying the trigger command.

Preferred embodiments of the present disclosure have been described in detail with reference to the accompanying drawings, but the present disclosure is not limited to the specific details of the above embodiments. Within the scope of the technical conception of the present disclosure, various simple modifications may be made to the technical scheme of the present disclosure, and these simple modifications all fall within the scope of protection of the present disclosure. For example, each of the specific technical features described in the above specific embodiments may be combined in any suitable manner without contradiction, and various possible combinations are not further described in this disclosure in order to avoid unnecessary repetition. For another example, any combination may be made between the various embodiments of the present disclosure so long as it does not depart from the idea of the present disclosure and is also to be regarded as the present disclosure of the present disclosure. For another example, on the premise of no conflict, each embodiment described in the present disclosure and/or the technical features in each embodiment may be arbitrarily combined with the prior art, and the technical scheme obtained after the combination should also fall within the scope of protection of the present disclosure.

It should be understood that, in various embodiments of the present disclosure, the sequence numbers of the above processes do not imply the sequence of execution, and the sequence of execution of each process should be determined according to its functions and internal logic, and should not constitute any limitation on the implementation process of the embodiments of the present disclosure. Furthermore, in embodiments of the present disclosure, the terms “downlink”, “uplink” and “sidelink” are used to represent the transmission direction of the signal or data, where the term “downlink” is used to represent a transmission direction of the signal or data as a first direction transmitted from a site to the user equipment of the cell, the term “uplink” is used to represent a transmission direction of the signal or data as a second direction transmitted from the user equipment of the cell to the site, and the term “sidelink” is used to represent a transmission direction of the signal or data as a first direction transmitted from the user equipment 1 to the user equipment 2. For example, a term “downlink signal” means that the transmission direction of the signal is a first direction. In addition, in embodiments of the present disclosure, the term “and/or” is only an association relationship describing associated objects and represents that three relationships may exist. For example, A and/or B may represent three conditions: i.e., independent existence of A, existence of both A and B and independent existence of B. In addition, the character “/” in the present disclosure generally indicates that the relationship between the associated objects is “or”.

A schematic structural diagram of a communication apparatus according to an embodiment of the present disclosure is described as follows. The communication apparatus may be applied to a terminal device. The communication apparatus includes an acquiring unit and a determining unit.

The acquiring unit is configured to acquire a first offset increment configured by a network device.

The determining unit is configured to determine a terminal device-specific offset according to the first offset increment and a cell-level common offset.

The determining unit is further configured to determine a time-domain resource position for an uplink transmission of the terminal device according to the terminal device-specific offset.

In some embodiments, the first offset increment is an increment between the terminal device-specific offset and the cell-level common offset.

In some embodiments, the determining unit is further configured to:
determine the terminal device-specific offset according to a sum of the cell-level common offset and the first offset increment; or
determine the terminal device-specific offset according to a difference between the cell-level common offset and the first offset increment.

In some embodiments, the cell-level common offset is transmitted by the network device through broadcasting.

In some embodiments, the first offset increment is transmitted by the network device through dedicated signaling.

A schematic structural diagram of a communication apparatus according to another embodiment of the present disclosure is described as follows. The communication apparatus may be applied to a terminal device. The communication apparatus includes a determining unit.

The determining unit is configured to determine whether the terminal device has a terminal device-specific offset.

The determining unit is further configured to determine, according to a determination result, that the terminal device-specific offset is determined based on a cell-level common offset and/or an adjusted terminal device-specific offset is determined based on the terminal device-specific offset.

The determining unit is further configured to determine a time-domain resource position for an uplink transmission of the terminal device according to a determined terminal device-specific offset.

In some embodiments, the determining unit is further configured to:
in a case where the terminal device does not have the terminal device-specific offset, determine the terminal device-specific offset according to the cell-level common offset and a first offset increment; and
in a case where the terminal device has the terminal device-specific offset, determine the adjusted terminal device-specific offset according to the terminal device-specific offset and a second offset increment.

In some embodiments, the determining unit is further configured to:
acquire the second offset increment configured by the network device, where the second offset increment is an increment between the terminal device-specific offset and the adjusted terminal device-specific offset; and
determine the adjusted terminal device-specific offset according to the terminal device-specific offset and the second offset increment.

In some embodiments, the determining unit is further configured to:
determine the adjusted terminal device-specific offset according to a sum of the terminal device-specific offset and the second offset increment; or
determine the adjusted terminal device-specific offset according to a difference between the terminal device-specific offset and the second offset increment.

In some embodiments, the second offset increment is transmitted by the network device through dedicated signaling.

In some embodiments, the determining unit is further configured to:
acquire the first offset increment configured by the network device, where the first offset increment is an increment between the terminal device-specific offset and the cell-level common offset of the terminal device; and
determine the terminal device-specific offset according to the cell-level common offset and the first offset increment.

In some embodiments, the determining unit is further configured to:
determine the terminal device-specific offset according to a sum of the cell-

level common offset and the first offset increment; or
determine the terminal device-specific offset according to a difference between the cell-level common offset and the first offset increment.

In some embodiments, the first offset increment is transmitted by the network device through dedicated signaling.

A schematic structural diagram of a communication apparatus according to another embodiment of the present disclosure is described as follows. The communication apparatus may be applied to a terminal device. The communication apparatus includes a determining unit.

The determining unit is configured to determine whether the terminal device has a terminal device-specific offset.

The determining unit is further configured to: according to a determination result, determine the terminal device-specific offset and/or determine an adjusted terminal device-specific offset based on the terminal device-specific offset.

The determining unit is further configured to: determine a time-domain resource position for an uplink transmission of the terminal device according to a determined terminal device-specific offset.

In some embodiments, the determining unit is further configured to:
in a case where the terminal device does not have the terminal device-specific offset, acquire the terminal device-specific offset; and
in a case where the terminal device has the terminal device-specific offset, determine the adjusted terminal device-specific offset according to the terminal device-specific offset and a second offset increment, where the second offset increment is an increment between the terminal device-specific offset and the adjusted terminal device-specific offset.

In some embodiments, the determining unit is further configured to:
determine the terminal device-specific offset according to a sum of the terminal device-specific offset and the second offset increment; or
determine the terminal device-specific offset according to a difference between the terminal device-specific offset and the second offset increment.

In some embodiments, the communication apparatus further includes an acquiring unit configured to:
acquire first signaling configured by the network device, where the first signaling is used for configuring the terminal device-specific offset; and/or
acquire second signaling configured by the network device, where the second signaling is used for configuring the second offset increment.

In some embodiments, the first signaling includes a long MAC CE and the second signaling includes a short MAC CE, and the long MAC CE has a payload length greater than a payload length of the short MAC CE.

In some embodiments, the first signaling includes dedicated RRC signaling and the second information includes an MAC CE.

A schematic structural diagram of a communication apparatus according to another embodiment of the present disclosure is described as follows. The communication apparatus may be applied to a network device. The communication apparatus includes a configuring unit and a determining unit.

The configuring unit is configured to configure a first offset increment for a terminal device.

The determining unit is configured to determine a terminal device-specific offset according to the first offset increment and a cell-level common offset.

The determining unit is further configured to a time-domain resource position for an uplink transmission of the terminal device according to the terminal device-specific offset.

In some embodiments, the first offset increment is an increment between the terminal device-specific offset and the cell-level common offset.

In some embodiments, the determining unit is further configured to:
determine the terminal device-specific offset according to a sum of the cell-level common offset and the first offset increment; or
determine the terminal device-specific offset according to a difference between the cell-level common offset and the first offset increment.

In some embodiments, the cell-level common offset is transmitted by the network device through broadcasting.

In some embodiments, the first offset increment is transmitted by the network device through dedicated signaling.

A schematic structural diagram of a communication apparatus according to another embodiment of the present disclosure is described as follows. The communication apparatus may be applied to a network device. The communication apparatus includes a determining unit.

The determining unit is configured to determine whether a terminal device has a terminal device-specific offset.

The determining unit is further configured to determine, according to a determination result, that the terminal device-specific offset is determined based on a cell-level common offset and/or an adjusted terminal device-specific offset is determined based on the terminal device-specific offset.

The determining unit is further configured to determine a time-domain resource position for an uplink transmission of the terminal device according to a determined terminal device-specific offset.

In some embodiments, the determining unit is further configured to:
in a case where the terminal device does not have the terminal device-specific offset, determine the terminal device-specific offset according to the cell-level common offset and a first offset increment; and
in a case where the terminal device has the terminal device-specific offset, determine the adjusted terminal device-specific offset according to the terminal device-specific offset and a second offset increment.

In some embodiments, the determining unit is further configured to:
configure the second offset increment for the terminal device, where the second offset increment is an increment between the terminal device-specific offset and the adjusted terminal device-specific offset; and
determine the adjusted terminal device-specific offset according to the terminal device-specific offset and the second offset increment.

In some embodiments, the determining unit is further configured to:
determine the adjusted terminal device-specific offset according to a sum of the terminal device-specific offset and the second offset increment; or
determine the adjusted terminal device-specific offset according to a difference between the terminal device-specific offset and the second offset increment.

In some embodiments, the second offset increment is transmitted by the network device through dedicated signaling.

In some embodiments, the determining unit is further configured to:
configure the first offset increment for the terminal device, where the first offset increment is an increment between the terminal device-specific offset and the cell-level common offset of the terminal device; and
determine the terminal device-specific offset according to the cell-level common offset and the first offset increment.

In some embodiments, the determining unit is further configured to:
determine the terminal device-specific offset according to a sum of the cell-level common offset and the first offset increment; or
determine the terminal device-specific offset according to a difference between the cell-level common offset and the first offset increment.

In some embodiments, the first offset increment is transmitted by the network device through dedicated signaling.

A schematic structural diagram of a communication apparatus according to yet another embodiment of the present disclosure is described as follows. The communication apparatus may be applied to a network device. The communication apparatus includes a determining unit.

The determining unit is configured to determine whether a terminal device has a terminal device-specific offset.

The determining unit is further configured to: according to a determination result, determine the terminal device-specific offset and/or determine an adjusted terminal device-specific offset based on the terminal device-specific offset.

The determining unit is further configured to determine a time-domain resource position for an uplink transmission of the terminal device according to a determined terminal device-specific offset.

In some embodiments, the determining unit is further configured to:
in a case where the terminal device does not have the terminal device-specific offset, acquire the terminal device-specific offset; and
in a case where the terminal device has the terminal device-specific offset, determine the adjusted terminal device-specific offset according to the terminal device-specific offset and a second offset increment, where the second offset increment is an increment between the terminal device-specific offset and the adjusted terminal device-specific offset.

In some embodiments, the determining unit is further configured to:
determine the terminal device-specific offset according to a sum of the terminal device-specific offset and the second offset increment; or
determine the terminal device-specific offset according to a difference between the terminal device-specific offset and the second offset increment.

In some embodiments, the communication apparatus further includes a configuring unit configured to:
configure first signaling for the terminal device, where the first signaling is used for configuring an terminal device-specific offset, and/or
configure second signaling for the terminal device, where the second signaling is used for configuring the second offset increment.

In some embodiments, the first signaling includes a long MAC CE and the second signaling includes a short MAC CE, the long MAC CE having a payload length greater than a payload length of the short MAC CE.

In some embodiments, the first signaling includes dedicated RRC signaling and the second information includes an MAC CE.

Those skilled in the art will appreciate that the above-described description of the communication apparatus in the embodiment of the present disclosure may be understood with reference to the description of the communication method in the embodiment of the present disclosure.

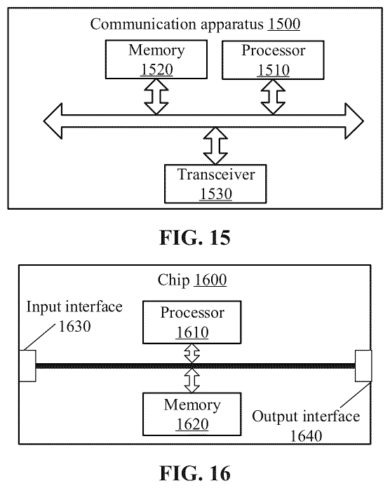

FIG. 15 is a schematic structural diagram of a communication apparatus according to an embodiment of the present disclosure. The communication apparatus may be a terminal device or a network device. The communication apparatus 1500 shown in FIG. 15 includes a processor 1510 and a memory 1520 that stores a computer program executable on the processor, and the processor 1510 implements the method in the embodiment of the present disclosure when the processor 1510 executes the program.

The memory 1520 may be a separate device independent of the processor 1510 or the memory 1520 may be integrated into the processor 1510.

In some embodiments, as shown in FIG. 15, the communication apparatus 1500 may also include a transceiver 1530. The processor 1510 may control the transceiver 1530 to communicate with other devices, in particular, to send information or data to other devices, or receive information or data sent by other devices.

The transceiver 1530 may include a transmitter and a receiver. The transceiver 1530 may further include an antenna(s), the number of which may be one or more.

In some embodiments, the communication apparatus 1500 may be specifically a network device in the embodiments of the present disclosure, and the communication apparatus 1500 may implement the corresponding process implemented by the network device in each method of the embodiments of the present disclosure, which will not be repeated herein for the sake of brevity.

In some embodiments, the communication apparatus 1500 may be a terminal device according to the embodiments of the present disclosure, and the communication apparatus 1500 may implement the corresponding flows implemented by the terminal device in each method of the embodiments of the present disclosure, which will not be repeated herein for the sake of brevity.

The embodiments of the present disclosure also provide a computer storage medium storing one or more programs executable by one or more processors to implement the method in the embodiment of the present disclosure.

In some embodiments, the computer storage medium may be applied to the network device in the embodiment of the present disclosure, and the computer program causes the computer to execute the corresponding flows implemented by the network device in each method of the embodiments of the present disclosure, which will not be repeated herein for the sake of brevity.

In some embodiments, the computer storage medium may be applied to the terminal device in the embodiment of the present disclosure, and the computer program causes the computer to execute the corresponding flows implemented by the terminal device in each method of the embodiments of the present disclosure, which will not be repeated herein for the sake of brevity.

FIG. 16 is a schematic structural diagram of a chip according to an embodiment of the present disclosure. The chip 1600 shown in FIG. 16 includes a processor 1610 that may invoke and run a computer program from a memory to implement the method in the embodiment of the present disclosure.

In some embodiments, as shown in FIG. 16, the chip 1600 may also include a memory 1620. The processor 1610 may invoke and run a computer program from the memory 1620 to implement the method in the embodiment of the present disclosure.

The memory 1620 may be a separate device independent of the processor 1610 or may be integrated in the processor 1610.

In some embodiments, the chip 1600 may also include an input interface 1630. The processor 1610 may control the input interface 1630 to communicate with other devices or chips, and in particular may obtain information or data sent by other devices or chips.

In some embodiments, the chip 1600 may also include an output interface 1640. The processor 1610 may control the output interface 1640 to communicate with other devices or chips, and in particular may output information or data to other devices or chips.

In some embodiments, the chip may be applied to the network device in the embodiments of the present disclosure, and the chip may implement the corresponding process implemented by the network device in each method of the embodiments of the disclosure, which is not repeated herein for the sake of brevity.

In some embodiments, the chip may be applied to the terminal device in the embodiments of the present disclosure, and the chip may implement the corresponding flows implemented by the terminal device in each method of the embodiment of the disclosure. For the sake of simplicity, which will not be repeated herein for the sake of brevity.

It is to be understood that chips mentioned in the embodiments of the present disclosure may also be referred to as system level chips, system chips, chip systems or on-chip system chips, etc.

The embodiments of the present disclosure further provide a computer program product including a computer storage medium. The computer storage medium stores a computer program including instructions executable by at least one processor, and the method of the present disclosure is implemented when the instructions are executed by the at least one processor.

In some embodiments, the computer program product may be applied to a network device in the embodiments of the disclosure. The computer program instruction enables a computer to execute corresponding flows implemented by the network device in each method of the embodiments of the disclosure, which will not be elaborated here for simplicity.

In some embodiments, the computer program product may be applied to a terminal device in the embodiments of the disclosure. The computer program instruction enables a computer to execute corresponding flows implemented by the terminal device in each method of the embodiments of the disclosure, which will not be elaborated herein for simplicity. In some embodiments, the computer program product may be referred to as a software product.

The embodiments of the present disclosure further provide a computer program that causes a computer to perform the method in the embodiment of the present disclosure.

In some embodiments, the computer program may be applied to a network device in the embodiments of the disclosure. The computer program runs in a computer to enable the computer to execute corresponding flows implemented by the network device in each method of the embodiments of the disclosure, which will not be elaborated here for simplicity. In some embodiments, the computer program may be applied to the terminal device in the embodiments of the disclosure. When running on a computer, the computer program enables a computer to execute corresponding flows implemented by the terminal device in each method of the embodiments of the disclosure, which will not be elaborated here for simplicity.

Those skilled in the art will appreciate that the above-described descriptions of the communication apparatus, the computer storage medium, the chip, the computer program product, and the computer program in the embodiment of the present disclosure may be understood with reference to the description of the communication method in the embodiment of the present disclosure.

The processor in the embodiments of the disclosure may be an integrated circuit chip with signal processing capacity. In an implementation process, various steps of the above method embodiments may be completed by an integrated logic circuit of hardware in the processor or an instruction in the form of software. The above processor may include an integration of any one or more of the following: a general-purpose processor, an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a Graphics Processing Unit (GPU), neural-network processing units (NPU), a controller, a microcontroller, a microprocessor, a programmable logic device, a discrete gate or a transistor logic device, or a discrete hardware component. Various methods, steps, and logical block diagrams disclosed in the embodiments of the disclosure may be implemented or performed. The general-purpose processor may be a microprocessor, any conventional processor, or the like. Steps of the methods disclosed with reference to the embodiments of the disclosure may be directly performed and accomplished by a hardware decoding processor, or may be performed and accomplished by a combination of hardware and software modules in the decoding processor. The software module may be located in a storage medium mature in the art, such as a random access memory, a flash memory, a read-only memory, a programmable read-only memory or electrically erasable programmable memory, or a register. The storage medium is located in the memory, and the processor reads information in the memory and completes the steps in the foregoing methods in combination with hardware of the processor.

It may be understood that the memory or the computer storage medium in the embodiments of the disclosure may be a volatile memory or a nonvolatile memory, or may include a volatile memory and a nonvolatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a RAM, which is used as an external high-speed cache. By way of example but not restrictive description, many forms of RAMs may be used, for example, a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). It is to be noted that the memory of the systems and methods described in this specification includes but is not limited to these and any other proper types of memories.

It is to be understood that the abovementioned memories or the or computer storage medium are exemplary but not restrictive, for example, the memory in the embodiments of the disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM). That is to say, the memories described in the embodiment of the disclosure are intended to include, but not limited to, these and any other suitable types of memories.

Those of ordinary skill in the art may be aware that the units and algorithm steps in the examples described with reference to the embodiments disclosed in this specification can be implemented by electronic hardware or a combination of computer software and electronic hardware. Whether the functions are performed by hardware or software depends on particular applications and design constraints of the technical solutions. A person skilled in the art may realize the described functions for each particular disclosure by different methods, but it is not be considered that the implementation is beyond the scope of the disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described again herein.

In the several embodiments provided in the disclosure, it is to be understood that the disclosed system, apparatus, and method may be implemented in other modes. For example, the apparatus embodiment described above is only schematic, and for example, division of the units is only logic function division, and other division manners may be adopted during practical implementation. For example, multiple units or components may be combined or integrated into another system, or some characteristics may be neglected or not executed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated, and the components displayed as units may or may not be physical units, and may be located in one place or may be distributed over multiple network units. Some or all of the units may be selected according to actual needs to achieve the objectives of the solutions of the embodiments.

In addition, functional units in various embodiments of the disclosure may be integrated into one processing unit, or each of the units may be physically separated, or two or more units may be integrated into one unit.

When the functions are realized in a form of a software functional unit and sold or used as an independent product, they may be stored in a computer-readable storage medium. Based on this understanding, the technical solutions of the embodiments of the disclosure essentially or the parts that contribute to the prior art, or part of the technical solutions can be embodied in the form of a software product. The computer software product is stored in a storage medium, including multiple instructions for causing a computer device (which may be a personal computer, a server, or a network device, and the like) to execute all or part of the steps of the method described in the embodiments of the disclosure. The foregoing storage medium includes a USB flash disk, a mobile hard disk drive, an ROM, an RAM, and various media that can store program codes, such as a magnetic disk or an optical disk.

The above descriptions are merely specific implementations of the disclosure, but are not intended to limit the scope of protection of the disclosure. Any variation or replacement readily figured out by a person skilled in the art within the technical scope disclosed in the disclosure shall fall within the scope of protection of the disclosure. Therefore, the scope of protection of the disclosure is defined by the scope of protection of the claims.

1. A communication method, comprising:
acquiring, by a terminal device, a first offset increment configured by a network device;
determining, by the terminal device, a terminal device-specific offset according to the first offset increment and a cell-level common offset; and
determining, by the terminal device, a time-domain resource position for an uplink transmission of the terminal device according to the terminal device-specific offset.

2. The method of claim 1, wherein the first offset increment is an increment between the terminal device-specific offset and the cell-level common offset.

3. The method of claim 1, wherein determining, by the terminal device, the terminal device-specific offset according to the first offset increment and the cell-level common offset comprises:
determining, by the terminal device, the terminal device-specific offset according to a sum of the cell-level common offset and the first offset increment; or
determining, by the terminal device, the terminal device-specific offset according to a difference between the cell-level common offset and the first offset increment.

4. The method of claim 2, wherein determining, by the terminal device, the terminal device-specific offset according to the first offset increment and the cell-level common offset comprises:
determining, by the terminal device, the terminal device-specific offset according to a sum of the cell-level common offset and the first offset increment; or
determining, by the terminal device, the terminal device-specific offset according to a difference between the cell-level common offset and the first offset increment.

5. The method of claim 1, wherein
the cell-level common offset is transmitted by the network device through broadcasting.

6. The method of claim 2, wherein
the cell-level common offset is transmitted by the network device through broadcasting.

7. The method of claim 3, wherein
the cell-level common offset is transmitted by the network device through broadcasting.

8. The method of claim 1, wherein
the first offset increment is transmitted by the network device through dedicated signaling.

9. A communication method, comprising:
configuring, by a network device, a first offset increment for a terminal device;
determining, by the network device, a terminal device-specific offset according to the first offset increment and a cell-level common offset; and
determining, by the network device, a time-domain resource position for an uplink transmission of the terminal device according to the terminal device-specific offset.

10. The method of claim 9, wherein the first offset increment is an increment between the terminal device-specific offset and the cell-level common offset.

11. The method of claim 9, wherein determining, by the network device, the terminal device-specific offset according to the first offset increment and the cell-level common offset comprises:
determining, by the network device, the terminal device-specific offset according to a sum of the cell-level common offset and the first offset increment; or
determining, by the network device, the terminal device-specific offset according to a difference between the cell-level common offset and the first offset increment.

12. The method of claim 9, wherein
the cell-level common offset is transmitted by the network device through broadcasting.

13. The method of claim 9, wherein
the first offset increment is transmitted by the network device through dedicated signaling.

14. A communication apparatus, comprising:
a processor;
a transceiver connected to the processor; and
a memory configured to store instructions executable by the processor,
wherein the processor is configured to invoke and run the executable instructions to perform operations of:
acquiring a first offset increment configured by a network device;
determining a terminal device-specific offset according to the first offset increment and a cell-level common offset; and
determining a time-domain resource position for an uplink transmission of the terminal device according to the terminal device-specific offset.

15. The communication apparatus of claim 14, wherein the first offset increment is an increment between the terminal device-specific offset and the cell-level common offset.

16. The communication apparatus of claim 14, wherein determining the terminal device-specific offset according to the first offset increment and the cell-level common offset comprises:
determining the terminal device-specific offset according to a sum of the cell-level common offset and the first offset increment; or
determining the terminal device-specific offset according to a difference between the cell-level common offset and the first offset increment.

17. The communication apparatus of claim 15, wherein determining the terminal device-specific offset according to the first offset increment and the cell-level common offset comprises:
determining the terminal device-specific offset according to a sum of the cell-level common offset and the first offset increment; or
determining the terminal device-specific offset according to a difference between the cell-level common offset and the first offset increment.

18. The communication apparatus of claim 14, wherein the cell-level common offset is transmitted by the network device through broadcasting.

19. The communication apparatus of claim 15, wherein the cell-level common offset is transmitted by the network device through broadcasting.

20. The communication apparatus of claim 14, wherein the first offset increment is transmitted by the network device through dedicated signaling.
